(19) United States
(12) Patent Application Publication
(10) Pub. No.: US 2025/0319576 A1
(43) Pub. Date: Oct. 16, 2025

(54) Self-Stabilizing Screwdriver and Use Thereof

(71) Applicant: HANDY FAMM IP HOLDINGS, LLC, Boca Raton, FL (US)

(72) Inventor: Joshua White, Boca Raton, FL (US)

(21) Appl. No.: 19/169,870

(22) Filed: Apr. 3, 2025

Related U.S. Application Data
(60) Provisional application No. 63/632,446, filed on Apr. 10, 2024.
(60) Provisional application No. 63/671,868, filed on Jul. 16, 2024.

(51) Int. Cl. B25B 15/02

(52) U.S. Cl. CPC B25B 15/02

(57) ABSTRACT

The disclosed technology includes a self-stabilizing screwdriver. In one example, the self-stabilizing screwdriver may include a housing defining a housing cavity and including a base, a screwdriver bit extending from the base such that at least a portion of the screwdriver bit is positioned outside the housing, and a stabilizer coupled to a lower portion of the housing. The stabilizer may surround the portion of the screwdriver bit positioned outside the housing and may be configured to hold the self-stabilizing screwdriver in an upright position such that the screwdriver bit is perpendicular to a surface when the self-stabilizing screwdriver is not in use. The stabilizer may include a bottom surface configured to engage with the surface and to reduce lateral movement of the self-stabilizing screwdriver when the self-stabilizing screwdriver is in use.

### CROSS REFERENCE TO RELATED APPLICATIONS

The present application claims the benefit of priority to U.S. Provisional Patent Application No. 63/632,446, entitled “Self-Stabilizing Screwdriver and Use Thereof,” filed Apr. 10, 2024, and U.S. Provisional Patent Application No. 63/671,868, entitled “Self-Stabilizing Screwdriver and Use Thereof,” filed Jul. 16, 2024, the entireties of both of which are hereby incorporated by reference herein for all purposes.

### TECHNICAL FIELD

The technology described herein relates generally to screwdrivers with stabilizers.

### BACKGROUND

Screwdrivers are hand tools used to turn, tighten, or drive screws into a surface or object. To drive a screw into a surface or object, the tip of the screwdriver is aligned with a slot or slit in the screw and the screw is rotated in a clockwise direction. Driving the screw into the surface or object may require a user to turn the screwdriver, remove the screwdriver from the screw, realign the screwdriver with the screw, and turn again, repeating this process until the screw is in the desired position. It can often be difficult to hold the screwdriver in place while turning it and to align and realign the screwdriver with the screw, as the body is relatively narrow and there is a small point of contact between the screwdriver and the screw. Using a screwdriver can be particularly challenging for children or elderly individuals who may lack the dexterity to hold the screwdriver in place while turning it. Further, the tip of the screwdriver is often sharp and may provide a safety hazard for children.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes self-stabilizing screwdrivers and methods of using the same. Embodiments of the present disclosure may include a self-stabilizing screwdriver. The self-stabilizing screwdriver may include a housing defining a housing cavity, a screwdriver bit positioned at least partially inside the housing cavity, and a plurality of legs coupled to a lower portion of the housing. The plurality of legs may surround at least a portion of the screwdriver bit when the screwdriver bit is in an engaged position. The plurality of legs may include a bottom surface to engage with a surface when the self-stabilizing screwdriver is in operation.

Other examples or embodiments of the present disclosure may include a self-stabilizing screwdriver that includes a housing defining a housing cavity. The housing may include a top housing rotably coupled to a bottom housing. The bottom housing may define a bit aperture. A plurality of legs may be coupled to the bottom housing. The plurality of legs may be configured to move in an outward direction relative to the bottom housing as the self-stabilizing screwdriver is in operation. A screwdriver bit may be positioned within the housing. The screwdriver bit may include a shank and a tip positioned proximate the bit aperture. A ratchet device may be positioned within the housing. The ratchet device may include a drive gear defining an aperture. The screwdriver bit may be positioned within the aperture and coupled to the drive gear. An activation button may be positioned on a top surface of the housing. The activation button may be configured to push the screwdriver bit at least partially within the bit aperture when the activation button is engaged. A ratchet button may be positioned on a side surface of the housing. The ratchet button may be configured to activate the ratchet device to turn the screwdriver bit when the top housing is rotated relative to the bottom housing.

Further examples or embodiments of the present disclosure may include a method of using a self-stabilizing screwdriver. The method may include obtaining a self-stabilizing screwdriver that may include a housing defining a housing cavity, a screwdriver bit positioned at least partially inside the housing cavity, and a plurality of legs coupled to the housing. The screwdriver bit may include a tip. The method may further include aligning the tip with a screw on a surface, placing the plurality of legs on the surface around the screw, and turning the housing in a clockwise direction to turn the screwdriver bit into the screw. The plurality of legs may spread out along the surface as the screwdriver bit moves the screw closer to the surface.

Additional examples or embodiments of the present disclosure may include a self-stabilizing screwdriver that includes a housing defining a housing cavity. The housing may include a base. A screwdriver bit may extend from the base such that at least a portion of the screwdriver bit is positioned outside the housing. A stabilizer may be coupled to a lower portion of the housing. The stabilizer may surround the portion of the screwdriver bit positioned outside the housing. The stabilizer may be configured to hold the self-stabilizing screwdriver in an upright position such that the screwdriver bit is perpendicular to a surface when the self-stabilizing screwdriver is not in use. The stabilizer may include a bottom surface configured to engage with the surface and to reduce lateral movement of the self-stabilizing screwdriver when the self-stabilizing screwdriver is in use.

Other examples or embodiments of the present disclosure may include a self-stabilizing screwdriver that includes a housing defining a housing cavity. The housing may include a top housing, a bottom housing, wherein the bottom housing includes a base, and a bit aperture defined in the base, wherein the bit aperture provides access to the housing cavity. The self-stabilizing screwdriver may include a stabilizer coupled to the bottom housing. The stabilizer may include a plurality of stabilizer legs that are configured to move in an outward direction relative to the bottom housing when the self-stabilizing screwdriver is in operation. The self-stabilizing screwdriver may include a screwdriver bit that includes a body and a tip. The body may extend through the bit aperture such that the tip of the screwdriver bit is positioned outside the housing and is surrounded by the plurality of stabilizer legs.

Further examples or embodiments of the present disclosure may include a self-stabilizing screwdriver including a housing defining a housing cavity. The housing may include a top housing portion forming a screwdriver body and a bottom housing portion forming a housing ring. The housing ring may include a housing ring outer surface. A base may be coupled to the bottom housing portion. The base may include a bit aperture configured to receive a screwdriver bit. The self-stabilizing screwdriver may include a stabilizer that includes a stabilizer ring and a plurality of stabilizer legs coupled to the stabilizer ring. The stabilizer ring may include a stabilizer ring inner surface that couples to the housing ring outer surface. The stabilizer legs may be configured to spread out along a surface when the stabilizer is in contact with the surface and the self-stabilizing screwdriver is in use.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a front elevation view of a self-stabilizing screwdriver.

FIG. 2 is a rear elevation view of the self-stabilizing screwdriver of FIG. 1.

FIG. 3 is a right side view of the self-stabilizing screwdriver of FIG. 1.

FIG. 4 is a top plan view of the self-stabilizing screwdriver of FIG. 1.

FIG. 5 is a bottom isometric view of the self-stabilizing screwdriver of FIG. 1.

FIG. 6 is an exploded view of the self-stabilizing screwdriver of FIG. 1.

FIG. 7A is a front elevation view of the activation button of the self-stabilizing screwdriver of FIG. 1.

FIG. 7B is a bottom isometric view of the activation button of FIG. 7A.

FIG. 8A is a front elevation view of the drive gear of the self-stabilizing screwdriver of FIG. 1.

FIG. 8B is a top plan view of the drive gear of FIG. 8A.

FIG. 8C is a bottom plan view of the drive gear of FIG. 8A.

FIG. 8D is a bottom isometric view of the drive gear of FIG. 8A.

FIG. 9A is a front isometric view of the ratchet device of the self-stabilizing screwdriver of FIG. 1.

FIG. 9B is a top plan view of the ratchet device of FIG. 9A.

FIG. 9C is a rear isometric view of the ratchet device of FIG. 9A.

FIG. 10A is a rear isometric view of the front top housing of the self-stabilizing screwdriver of FIG. 1.

FIG. 10B is a front isometric view of the rear top housing of the self-stabilizing screwdriver of FIG. 1.

FIG. 11A is a front elevation view of the thrust device of the self-stabilizing screwdriver of FIG. 1.

FIG. 11B is a top isometric view of the thrust device of FIG. 11A.

FIG. 11C is a bottom plan view of the thrust device of FIG. 11A.

FIG. 12 is a front isometric view of the screwdriver bit of the self-stabilizing screwdriver of FIG. 1.

FIG. 13A is a front elevation view of the bottom housing of the self-stabilizing screwdriver of FIG. 1.

FIG. 13B is a top isometric view of the bottom housing of FIG. 13A.

FIG. 13C is a front isometric cross-section view of the bottom housing of FIG. 13B taken along line 13C-13C.

FIG. 13D is a bottom plan view of the bottom housing of FIG. 13A.

FIG. 14A is a right side top isometric view of the stabilizer of the self-stabilizing screwdriver of FIG. 1.

FIG. 14B is a left side top isometric view of the stabilizer of FIG. 14A.

FIG. 15 is a cross-section view of the self-stabilizing screwdriver of FIG. 1 taken along line 15-15.

FIG. 16 is a top plan view of the ratchet system of the self-stabilizing screwdriver of FIG. 1.

FIG. 17 is a bottom isometric view of another embodiment of a self-stabilizing screwdriver with eight legs.

FIG. 18 is a top plan view of another embodiment of a self-stabilizing screwdriver with three legs.

FIG. 19A is a front elevation view of another embodiment of a self-stabilizing screwdriver with leg joints.

FIG. 19B is a cross-section view of the self-stabilizing screwdriver of FIG. 19A.

FIG. 19C is an isometric view of the leg joints of the self-stabilizing screwdriver of FIG. 19A.

FIG. 20 is an exploded view of another embodiment of a self-stabilizing screwdriver.

FIG. 21 is a cross-section view of the self-stabilizing screwdriver of FIG. 20 taken along cross-section line 21-21 of the self-stabilizing screwdriver of FIG. 1, which is identical to the front elevation view of the self-stabilizing screwdriver of FIG. 20.

FIG. 22 is a rear isometric view of the housing of the self-stabilizing screwdriver of FIG. 20.

FIG. 23A is a rear isometric view of the front housing of the self-stabilizing screwdriver of FIG. 20.

FIG. 23B is a front isometric view of the rear housing of the self-stabilizing screwdriver of FIG. 20.

FIG. 24 is a top isometric view of the stabilizer of the self-stabilizing screwdriver of FIG. 20.

FIG. 25A is a front elevation view of a disclosed self-stabilizing screwdriver in a first position.

FIG. 25B is a front elevation view of a disclosed self-stabilizing screwdriver in a second position.

FIG. 26A is an exemplary cross-section view of a disclosed self-stabilizing screwdriver in a first position with a screw.

FIG. 26B is an exemplary cross-section view of a disclosed self-stabilizing screwdriver in a second position with a screw.

FIG. 27 is a flow chart illustrating a method of using a self-stabilizing screwdriver.

FIG. 28 is a flowchart illustrating a method of using a ratchet function of a disclosed self-stabilizing screwdriver.

### DETAILED DESCRIPTION

This disclosure is related to a self-stabilizing screwdriver. A disclosed self-stabilizing screwdriver includes a stabilizer that helps to stabilize the screwdriver as the screwdriver is rotated to turn or drive a screw into a surface or object and/or to unscrew or remove a screw from a surface or object. The stabilizer reduces or eliminates lateral movement or wobbling of the screwdriver as it is rotated. The stabilizer may surround the screwdriver head or tip to improve user safety.

Disclosed self-stabilizing screwdrivers may include a housing and a stabilizer. The stabilizer may be removably or fixedly coupled to the housing. The housing may at least partially enclose a screwdriver bit. The screwdriver bit may include a tip that extends outside of the housing. The stabilizer may surround the tip of the screwdriver bit. The stabilizer may have a bottom surface that is configured to engage with a surface and to reduce lateral movement of the self-stabilizing screwdriver when the self-stabilizing screwdriver is in use or operation. The bottom surface of the stabilizer may slide along the surface in a direction away from the screwdriver bit when the stabilizer engages with the surface and the self-stabilizing screwdriver is in operation.

The stabilizer may include a plurality of stabilizer elements, which are also referred to herein as stabilizer legs or legs. The stabilizer elements may be coupled together by a ring, also referred to as a stabilizer ring. The stabilizer elements may be fixedly, flexibly, or hingedly coupled to the stabilizer ring. The stabilizer legs may surround the tip of the screwdriver bit. The stabilizer legs may have a bottom surface that makes up the stabilizer bottom surface. The bottom surface of the stabilizer legs may be configured to engage with a surface and to reduce lateral movement of the self-stabilizing screwdriver when the self-stabilizing screwdriver is in use or operation.

In some embodiments, the housing may include a top housing and a bottom housing. The top housing and the bottom housing may be separate components or a single component. The top housing may form a top or upper portion of the housing or top or upper housing portion and the bottom housing may form a bottom or lower portion of the housing or bottom or lower housing portion.

In some embodiments, the ring may be coupled to the bottom housing. In embodiments where the ring is omitted, the stabilizer elements may be flexibly or hingedly coupled to the bottom housing. The ring and the bottom housing may be coupled together by a fastening mechanism, such as, for example, a bayonet connector. The ring and stabilizer elements may be removable from the bottom housing. The connection between the stabilizer and the housing may facilitate installation and removal of the stabilizer from the housing by an individual with poor or reduced dexterity, such as a child or elderly individual.

In some embodiments, the top housing and the bottom housing may rotate together. In these embodiments, the legs may rotate with the bottom housing or the bottom housing may rotate separate from the legs, which remain stationary as the top and bottom housing are rotated. In other embodiments, the top housing may rotate relative to the bottom housing. In these embodiments, the legs may be coupled to the bottom housing and may remain stationary as the top housing is rotated relative to the bottom housing.

The housing may be rotated to rotate the screwdriver bit and drive a screw into a surface or object. As the screwdriver bit drives the screw closer to the surface or object, the legs may spread in an outwards direction along the surface (e.g., a direction away from the screwdriver bit and housing) or object to maintain stability of the self-stabilizing screwdriver as the self-stabilizing screwdriver is operated. The legs may include a smooth or slippery material layer on a bottom surface to facilitate sliding along the surface or object.

The stabilizer may hold the self-stabilizing screwdriver in an upright or vertical position when the self-stabilizing screwdriver is not in use. For example, the legs may be positioned on a surface and may hold the housing upright such that the housing is positioned vertically above the screwdriver bit. The upright position of the screwdriver may be easier for a user to grab as opposed to a conventional screwdriver that lays flat on a surface.

In some embodiments, a disclosed self-stabilizing screwdriver may include a safety or activation button. For example, the screwdriver bit may be stored inside the housing in an inactivated or disengaged state. The activation button may push the screwdriver bit through an aperture defined in the housing so that at least a portion of the screwdriver bit, e.g., the tip, is disposed outside of the housing. The screwdriver bit tip may be positioned centrally between the legs in the engaged position. The screwdriver bit tip may not pass an end or bottom of the legs. In this manner, the tip may not interfere with contact between the legs and a surface, thereby maintaining the stability of the self-stabilizing screwdriver. When the self-stabilizing screwdriver is not in use, the activation button may be selected to retract the screwdriver bit tip back inside the housing. This functionality of the activation button may improve safety of the self-stabilizing screwdriver as it may shield a user from the screwdriver tip and prevent injury.

In some embodiments, a disclosed self-stabilizing screwdriver may include a ratchet system. The ratchet system may be positioned within the housing and may couple to the screwdriver bit either directly or via intermediary components. In these embodiments, the self-stabilizing screwdriver may include a ratchet activator or button that activates or unlocks or deactivates or locks the ratchet system. When the ratchet system is activated, the self-stabilizing screwdriver may operate in a similar manner as a ratchet. For example, the top housing may be repeatedly rotated partially clockwise and partially counterclockwise to rotate the screwdriver bit into a screw or unscrew or remove a screw. When the ratchet system is deactivated, the self-stabilizing screwdriver may operate in a similar manner as a conventional screwdriver. For example, the top housing may be rotated in a clockwise direction to screw in or fasten a screw and rotated in a counterclockwise direction to unscrew or remove a screw.

The ratcheting function of a disclosed self-stabilizing screwdriver facilitates use and stability of the screwdriver. With the ratcheting function, the self-stabilizing screwdriver may remain in contact with the screw as the screw is driven into a surface or object. With a conventional screwdriver, a user may turn the screwdriver until the user's wrist can no longer turn, at which point the user may need to lift the screwdriver from the screw to realign it in a position that allows the user to again turn the user's wrist. It may be difficult to realign the narrow screwdriver tip with the narrow slit of the screw, particularly for a child or elderly individual. By incorporating the ratcheting function with the disclosed self-stabilizing screwdriver, a user can avoid having to repeatedly lift and realign the screwdriver with the screw. The ratcheting function of a disclosed self-stabilizing screwdriver thereby further improves the stability of the self-stabilizing screwdriver during use.

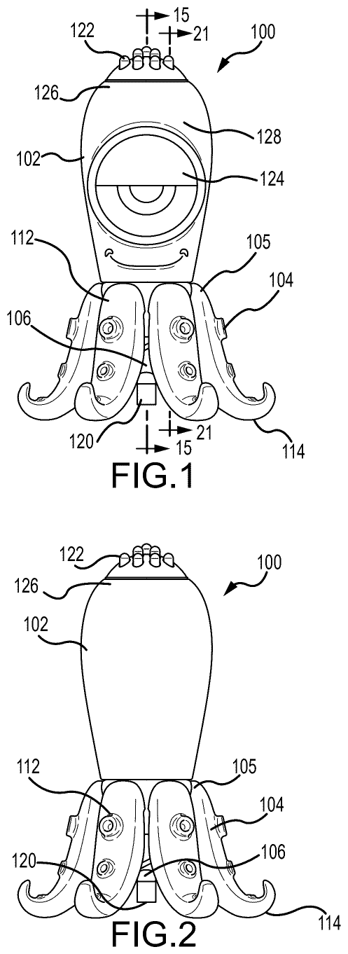

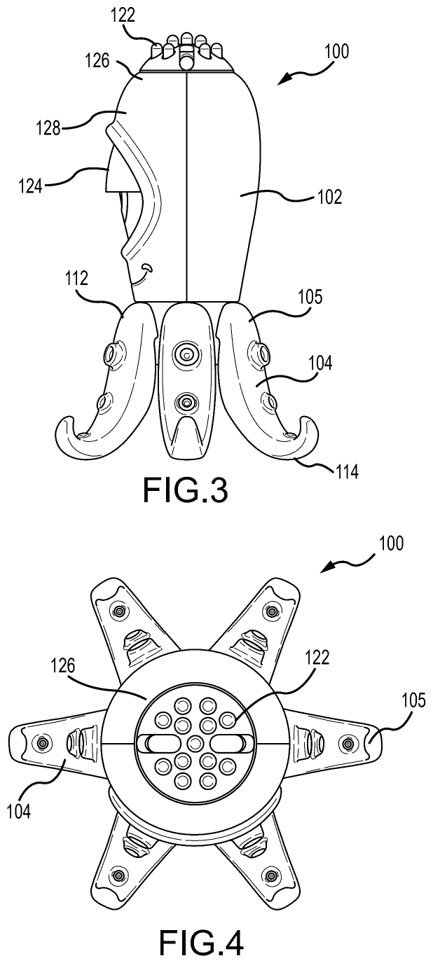

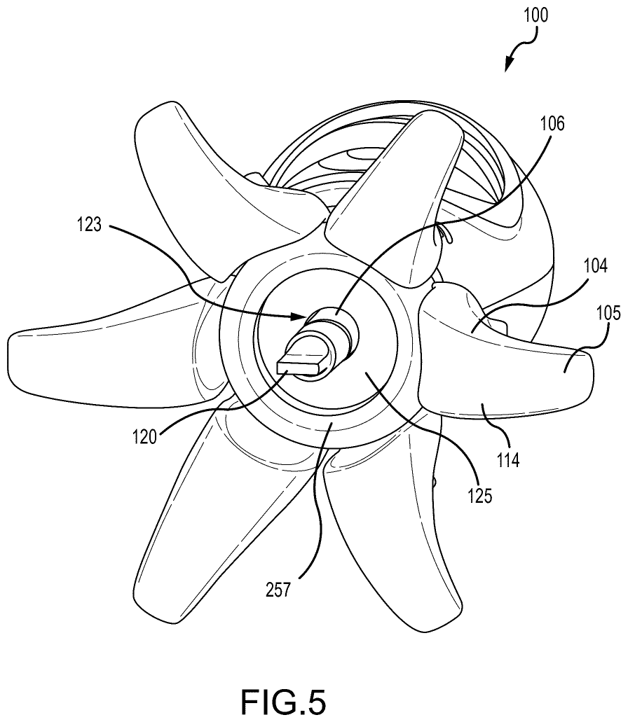

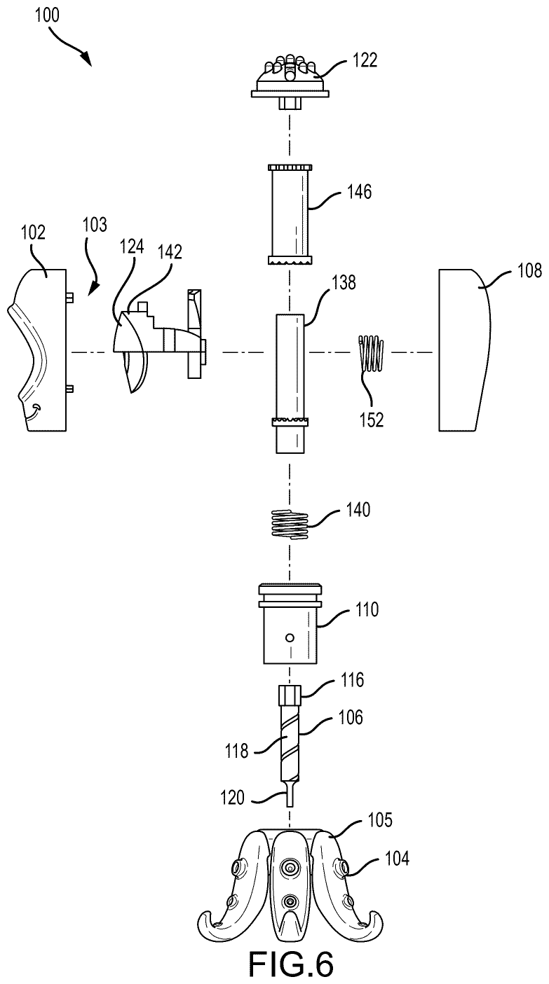

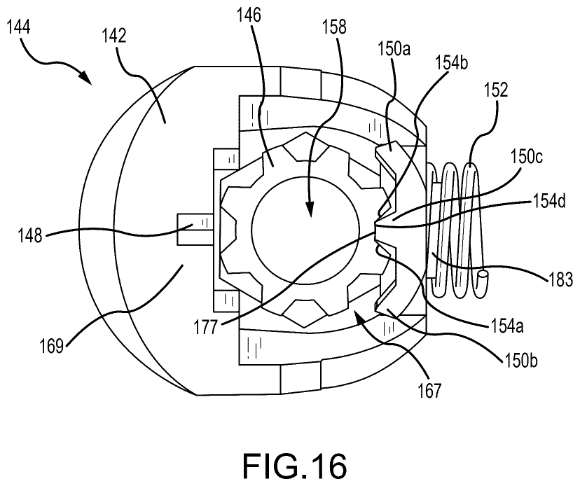

Turning to the figures, self-stabilizing screwdriver embodiments of the present disclosure will now be discussed in more detail. FIG. 1 is a front elevation view of a self-stabilizing screwdriver. FIG. 2 is a rear elevation view of the self-stabilizing screwdriver of FIG. 1. FIG. 3 is a left side view of the self-stabilizing screwdriver of FIG. 1. The right side view mirrors the left side view and is not shown for simplicity. FIG. 4 is a top plan view of the self-stabilizing screwdriver of FIG. 1. FIG. 5 is a bottom isometric view of the self-stabilizing screwdriver of FIG. 1. FIG. 6 is an exploded view of the self-stabilizing screwdriver of FIG. 1. As shown, the self-stabilizing screwdriver 100 may include a housing 102, a stabilizer 105, and a screwdriver bit 106. The housing 102 may define a housing cavity 103. The housing 102 may include a top housing 108 and a bottom housing 110. The top housing 108 may be rotably coupled to the bottom housing 110. In some embodiments, the top housing 108 may be fixedly coupled to the bottom housing 110. While the housing 102 is depicted with two separate parts, it is contemplated that the housing 102 may be a unitary housing made of a single part. For example, in embodiments without a ratchet system, such as the ratchet system 144 described with respect to FIG. 16, the housing 102 may be a unitary part. The housing 102 may also be a unitary part in embodiments with the ratchet systems described herein. The housing 102 may be made of a rigid or semi-rigid material. While various materials are contemplated, an exemplary material is a thermoplastic polymer such as Acrylonitrile Butadiene Styrene or ABS.

The stabilizer 105 may include a plurality of stabilizer elements or legs 104. The stabilizer elements or legs 104 may have elongated and tubular bodies 112. It is contemplated that the bodies 112 may have a rectangular shape. The legs 104 may include a bottom surface 114. The bottom surface 114 may be curved or the bottom surface 114 may be flat and angled to match a horizontal, flat surface. The stabilizer 105 and/or legs 104 may be made of a flexible material, such as, for example, a gel, polyurethane (e.g., thermoplastic polyurethane), rubber (e.g., thermoplastic rubber or TPR), and the like. The flexible material may have rigidity to retain its shape and stabilize the housing 102. The stabilizer 105 and/or legs 104 may include a reduced-friction material. In some embodiments, the bottom surface 114 may include a smooth or slippery material layer with reduced or low-friction properties to facilitate gliding along a surface. As an example, the bottom material layer of the bottom surface 114 of the legs 104 may be a UV (ultraviolet radiation) material coating.

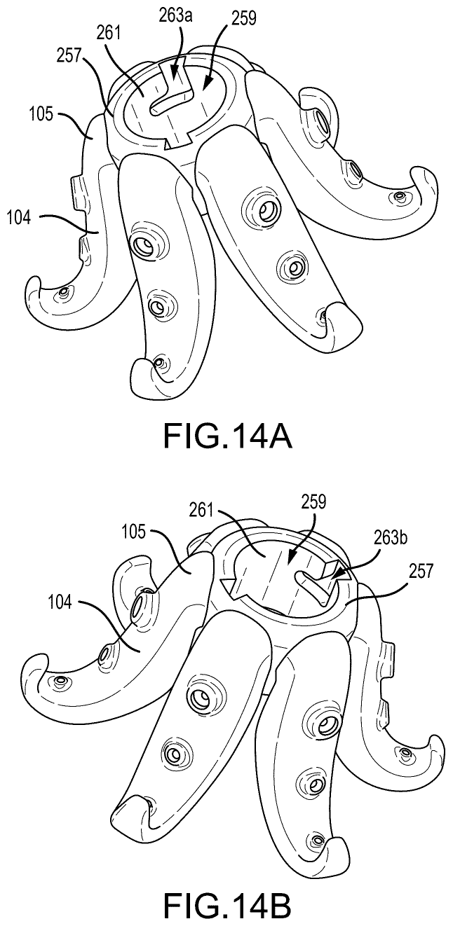

The stabilizer 105 may be coupled to a lower portion of the housing 102. In the depicted embodiment, the stabilizer 105 is coupled to the bottom housing 110. It is contemplated that the legs 104 may be coupled directly or indirectly to the housing 102 or bottom housing 110. In the depicted embodiment, the legs 104 are coupled to the bottom housing 110 by a stabilizer ring 257, as described in more detail with respect to FIGS. 14A-B; however, it is contemplated that the legs 104 may be directly coupled to the bottom housing 110. The legs 104 may be flexibly coupled to the stabilizer ring 257 or bottom housing 110 such that the legs 104 are capable of moving relative to the bottom housing 110. In some embodiments, the legs 104 may be formed by the housing 102 and may include cavities that are part of the housing cavity 103. In some embodiments, the legs 104 may be separate components coupled to the housing 102. In some embodiments, the legs 104 may be coupled together at a top portion of the legs 104 (e.g., via the stabilizer ring 257 or some other similar component). The legs 104 may be evenly spaced around the stabilizer ring 257. The legs 104 may be evenly spaced around the circumference of the housing 102. The self-stabilizing screwdriver 100 may include three or more legs. In the depicted embodiment, the self-stabilizing screwdriver 100 includes six legs 104; however, more or less legs are contemplated. For example, the self-stabilizing screwdriver 100 may include eight legs. Six legs provides coverage of the screwdriver bit 106, allowing less access to the screwdriver bit 106 and reducing the potential for a user to harm themselves on the sharp screwdriver bit 106, while allowing a user to see the screwdriver bit 106 to facilitate use of the screwdriver bit 106.

The screwdriver bit 106 may be contained within or contained partially within the housing cavity 103. The screwdriver bit 106 may be rotably coupled to or fixedly coupled to the housing 102. The screwdriver bit 106 may include a shank 116, a body 118, and a tip 120. It is contemplated that the tip 120 may be any type of standard screwdriver tip, including, for example, Phillips, flat head, Torx, Hex, slotted, Allen, and the like. In some embodiments, the tip 120 is fixed to the body 118. In other embodiments, the tip 120 is interchangeable with different types of standard screwdriver tips. In other words, the tip 120 may be removed from the body 118 and replaced with a different type of screwdriver tip. The tip 120 may include a magnet to facilitate location of and proper contact with a screw. The tip 120 may be covered by a cap.

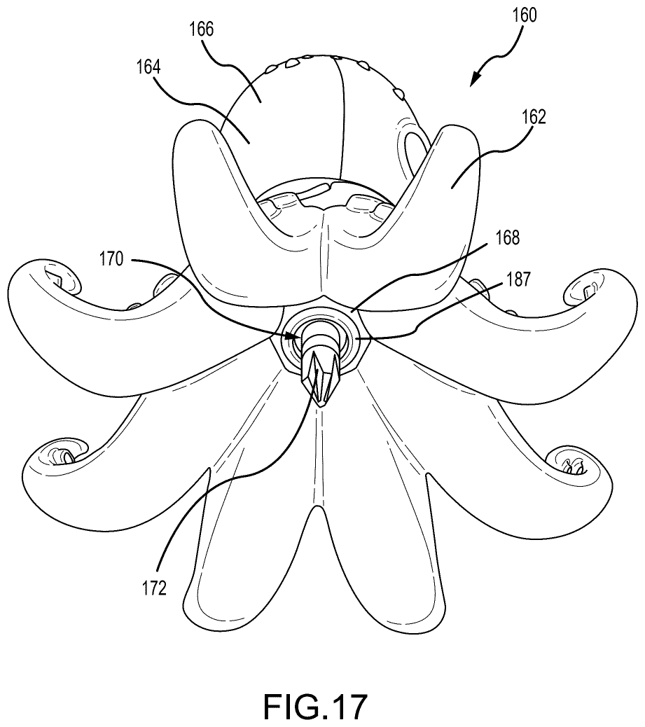

As shown in FIG. 5, the self-stabilizing screwdriver 100 may include a bit aperture 123 defined within a bottom surface or base 125 of the bottom housing 110. The bit aperture 123 may be configured to receive a screwdriver bit. In the depicted embodiment, the screwdriver bit 106 extends through the bit aperture 123. The bit aperture 123 may allow the screwdriver bit 106, including the tip 120, to pass therethrough when the self-stabilizing screwdriver 100 is in operation. In some embodiments, the bottom surface 125 may include a light, such as the light described with respect to FIG. 17.

In the depicted embodiment, as shown in FIGS. 1-4 and 6, the self-stabilizing screwdriver 100 includes an activation button 122 and a ratchet activator or button 124. The activation button 122 may be positioned on a top surface 126 of the housing 102. The ratchet activator or button 124 may be accessible to a user on a side surface 128 of the housing 102. However, it is contemplated that the activation button 122 and/or ratchet activator 124 may be positioned on different surfaces of the housing 102. For example, the ratchet activator 124 may be positioned on the top surface 126 of the housing and the activation button 122 may be omitted.

The components of the self-stabilizing screwdriver 100 will now be described in more detail with respect to FIGS. 6-16. As shown in FIG. 6, the self-stabilizing screwdriver 100 may include an activation button 122, a drive gear 146, a ratchet device 142, a top housing 108, a thrust device 138, a screwdriver bit 106, a bottom housing 110, and a stabilizer 105. It is contemplated that one or more of these component parts may be omitted.

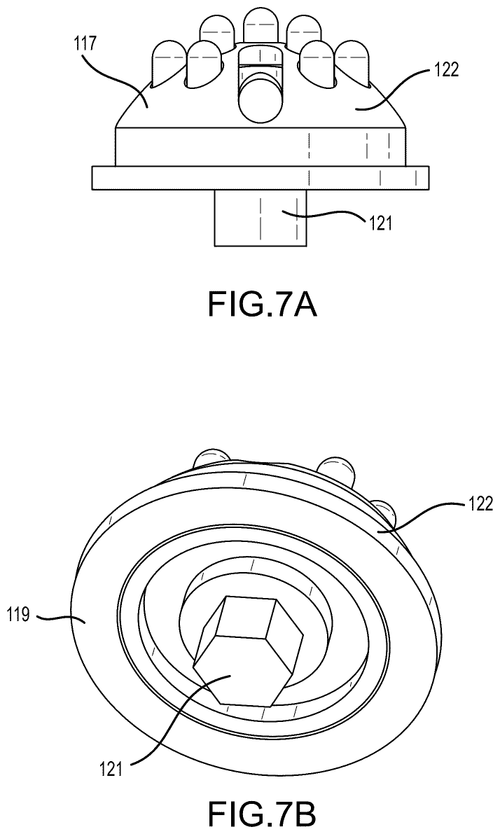

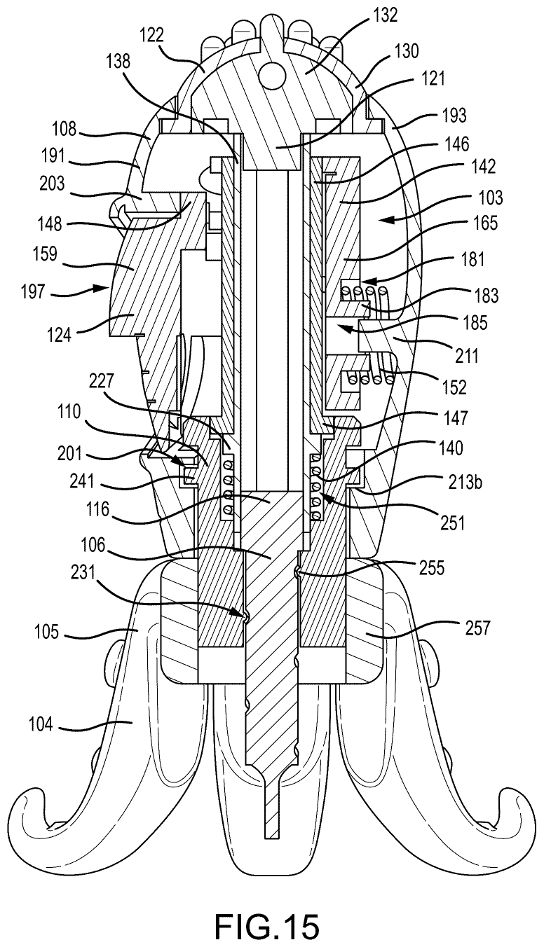

FIG. 7A is a front elevation view of the activation button 122 of the self-stabilizing screwdriver 100 of FIG. 1. FIG. 7B is a bottom isometric view of the activation button 122 of FIG. 7A. The activation button 122 may include a top surface 117 and a bottom surface 119. As shown, the top surface 117 has a convex curvature forming a dome shape activation button 122; however, it is contemplated that the activation button 122 may have any ergonomic shape. The bottom surface 119 includes a hexagonal boss or protrusion 121. As shown, the hexagonal boss 121 protrudes from a central position on the bottom surface 119. As shown in FIG. 15, the activation button 122 may include an outer cap or layer 130 and an inner cap or layer 132. However, a single cap or layer is contemplated.

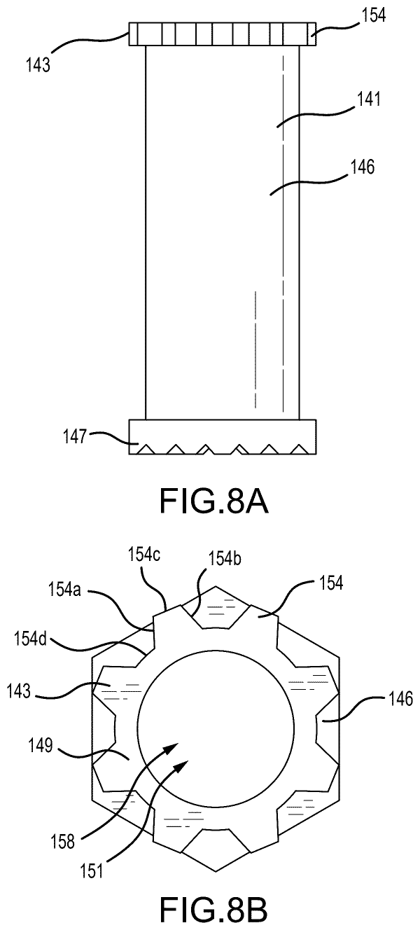

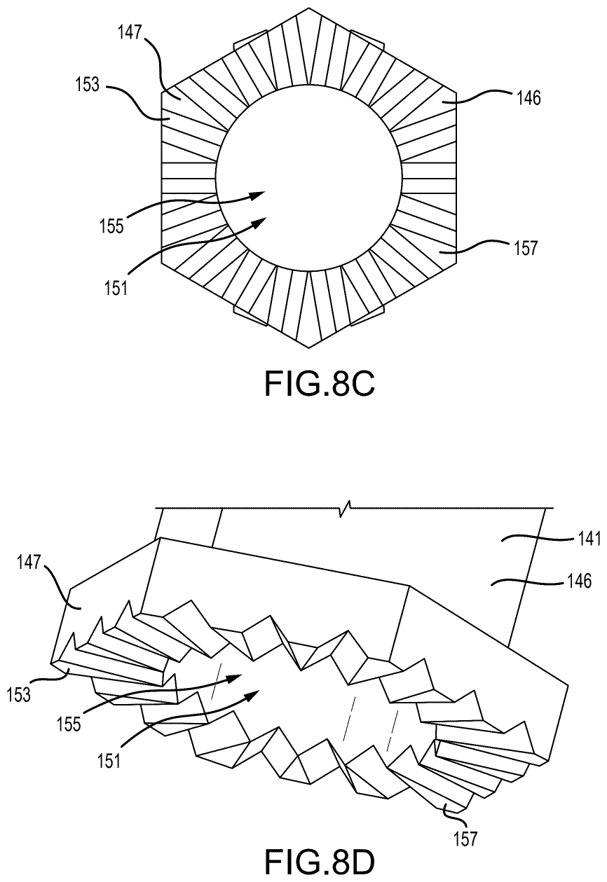

FIG. 8A is a front elevation view of the drive gear 146 of the self-stabilizing screwdriver 100 of FIG. 1. FIG. 8B is a top plan view of the drive gear 146 of FIG. 8A. FIG. 8C is a bottom plan view of the drive gear 146 of FIG. 8A. FIG. 8D is a bottom isometric view of the drive gear 146 of FIG. 8A. The drive gear 146 may include a tubular body 141. In the depicted embodiment, the tubular body 141 has a cylindrical shape. The drive gear 146 may include a first or top end 143 and a second or bottom end 147. The first or top end 143 may define a top surface 149. The top surface 149 may define a top aperture 158, which provides access to a central cavity 151. The drive gear 146 may include a plurality of gear teeth 154 at the top end 143. The gear teeth 154 may be evenly spaced apart. The gear teeth 154 may include a first sloping side 154a, a second sloping side 154b, and a flat outer surface 154c. The gaps between the gear teeth 154 may include a spacing surface 154d that spaces the gear teeth 154 a distance apart. The spacing surface 154d may be flat or relatively flat. As shown in FIG. 8C, the bottom end 147 may form a ring shape and may define a bottom surface 153. The bottom surface 153 may define a bottom aperture 155, which provides access to the central cavity 151. The bottom surface 153 may include a plurality of bottom teeth 157.

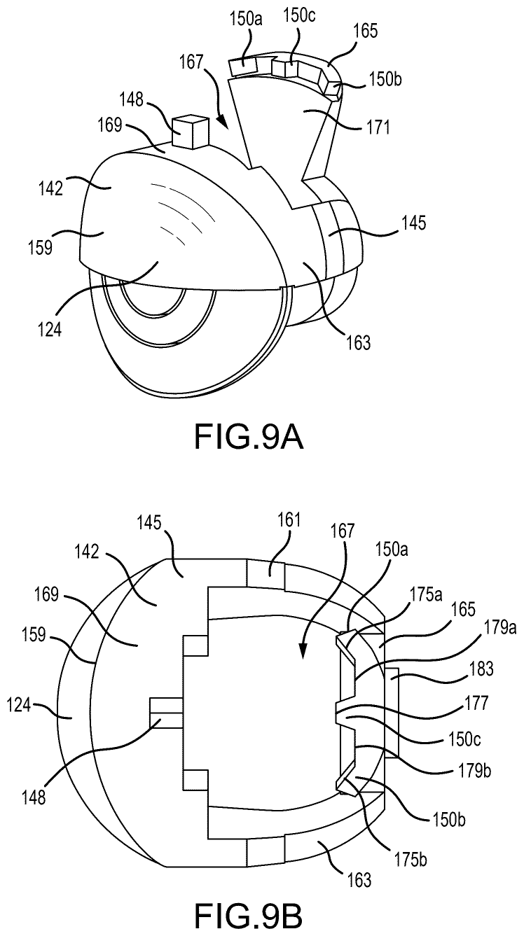

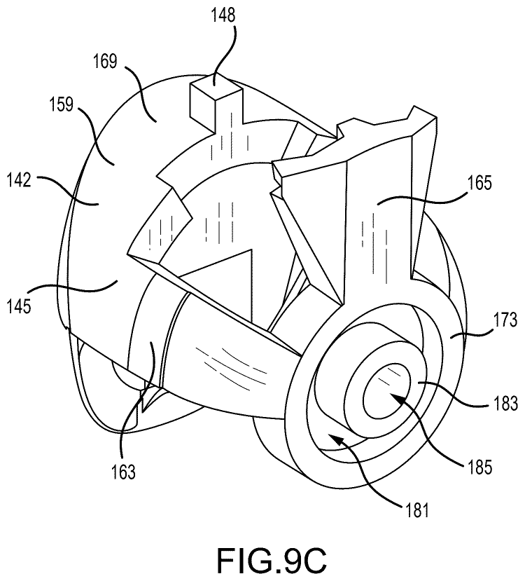

FIG. 9A is a front isometric view of the ratchet device 142 of the self-stabilizing screwdriver 100 of FIG. 1. FIG. 9B is a top plan view of the ratchet device 142 of FIG. 9A. FIG. 9C is a rear isometric view of the ratchet device 142 of FIG. 9A. As shown, the ratchet device 146 includes a ratchet housing 145. The ratchet housing 145 may include a ratchet front wall 159, a ratchet left sidewall 161, a ratchet right sidewall 163, and a ratchet rear wall 165. The ratchet front wall 159, ratchet left and right sidewalls 161, 163, and ratchet rear wall 165 may define a ratchet cavity 167 therebetween. The ratchet front wall 159 may include a locking boss 148 on a ratchet front wall top surface 169. The ratchet front wall 159 may form the ratchet activator 124 that is accessible by a user to activate the ratchet system. It is contemplated that the ratchet activator 124 may be made of one or more layers. For example, the ratchet activator 124 may be a single layer of material or may include an inner and outer layer. In some embodiments, the ratchet activator 124 is omitted. For example, the self-stabilizing screwdriver 100 may be operated as a ratchet or as a screwdriver.

The ratchet rear wall 165 may include a ratchet rear wall front surface 171 and a ratchet rear wall rear surface 173. The ratchet rear wall front surface 171 may include a plurality of ratchet teeth or bosses 150a,b,c. The ratchet teeth 150a,b,c may include a first outer ratchet tooth 150a and a second outer ratchet tooth 150b, collectively referred to as outer ratchet teeth 150a,b, and a central ratchet tooth 150c. The outer ratchet teeth 150a,b may include sloped surfaces 175a,b that slope in opposite directions. The central ratchet tooth 150c may have a flat surface 177. Gap surfaces 179a,b may be formed between the central ratchet tooth 150c and the outer ratchet teeth 150a,b, respectively. The gap surfaces 179a,b may be flat surfaces.

A circular channel or recess 181 may be defined in the ratchet rear wall rear surface 173 and may surround a ratchet central boss 183. The ratchet central boss 183 may define a central aperture 185. The ratchet central boss 183 may protrude outwards beyond the position of the ratchet rear wall rear surface 173.

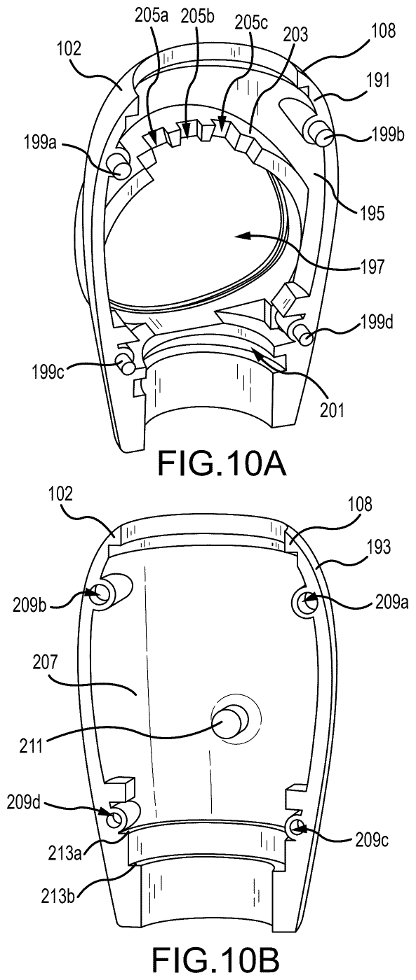

As discussed, the housing 102 may include a top housing 108. The top housing 108 may be made of a single component or multiple components. In the depicted embodiment, the top housing 108 is made of two components, a front top housing 191 and a rear top housing 193 that are coupled together. FIG. 10A is a rear isometric view of the front top housing 191 of the self-stabilizing screwdriver 100 of FIG. 1. FIG. 10B is a front isometric view of the rear top housing 193 of the self-stabilizing screwdriver 100 of FIG. 1. As shown, the front top housing 191 may include a rear surface 195. The rear surface 195 may have a concave shape and may define a front top housing aperture 197. The front top housing 191 may include a plurality of housing coupling bosses 199a,b,c,d that protrude outward from the rear surface 195. The rear surface 195 may define a curved recess or groove 201. The curved recess 201 may be positioned below the front top housing aperture 197. A curved wall 203 may extend out from the rear surface 195 and may be positioned above the front top housing aperture 197. The curved wall 203 may extend around an upper or top portion of the front top housing aperture 197. The curved wall 203 may have a plurality of notches or indentations 205a,b,c. The notches 205a,b,c may include a first outer notch 205a, a central notch 205b, and a second outer notch 205c. The notches 205a,b,c may be sized to correspond with a size of the locking boss 148.

The rear top housing 193 may include a front surface 207. The front surface 207 may have a concave shape. The rear top housing 193 may include a plurality of coupling apertures or recesses 209a,b,c,d that are located on the rear top housing 193 in positions that correspond to the positions of the coupling bosses 199a,b,c,d on the front top housing 191. The coupling recesses 209a,b,c,d are sized and shaped to correspond with a size and shape of the housing coupling bosses 199a,b,c,d. The rear top housing 193 may include a housing central boss 211 that extends from the front surface 207. The rear top housing 193 may include steps 213a,b that extend out from the front surface 207.

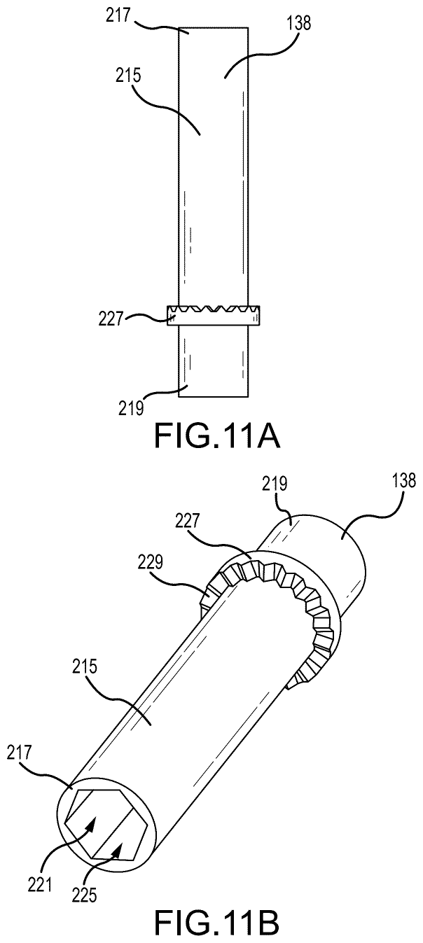

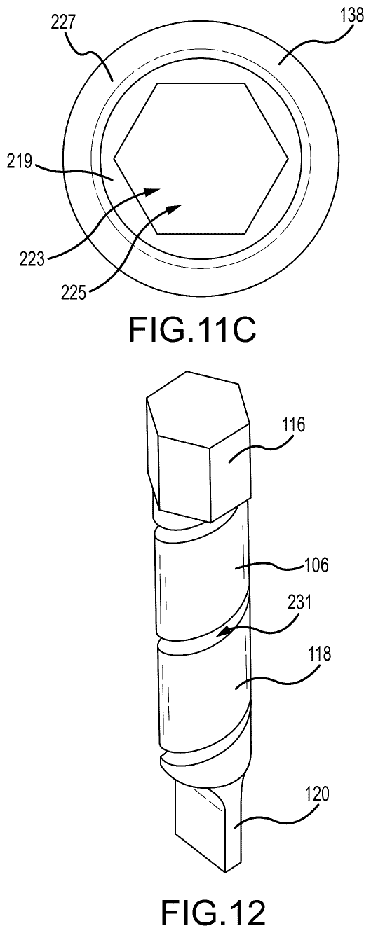

FIG. 11A is a front elevation view of the thrust device 138 of the self-stabilizing screwdriver 100 of FIG. 1. FIG. 11B is a top isometric view of the thrust device 138 of FIG. 11A. FIG. 11C is a bottom plan view of the thrust device 138 of FIG. 11A. As shown, the thrust device 138 may include a cylindrical housing 215. The thrust device 138 may have a first or top end 217 and a second or bottom end 219. The first end 217 may define a first aperture 221 and the second end 219 may define a second aperture 223. The first and second apertures 221, 223 may provide access to a thrust device cavity 225. The first and second apertures 221, 223 have a hexagonal shape; however other shapes are contemplated to correspond with shapes of other components of the self-stabilizing screwdriver 100 to which the thrust device 138 is coupled to or otherwise interacts with, as described in more detail below. The thrust device 138 may include a concentric ring 227 that surrounds the housing 215. The ring 227 may be positioned closer to the second end 219. The ring 227 may define a plurality of ring teeth 229 on a top surface of the ring 227.

FIG. 12 is a front isometric view of the screwdriver bit 106 of the self-stabilizing screwdriver 100 of FIG. 1. As shown, the screwdriver bit 106 may include a shank 116, a body 118, and a tip 120. In the depicted embodiment, the shank 116 has a hexagonal shape; however, other shapes are contemplated. The body 118 may be cylindrical. In the depicted embodiment, a helical channel or groove 231 is defined within the body 118. While a particular embodiment of a screwdriver bit 106 is depicted, other conventional screwdriver bits are contemplated.

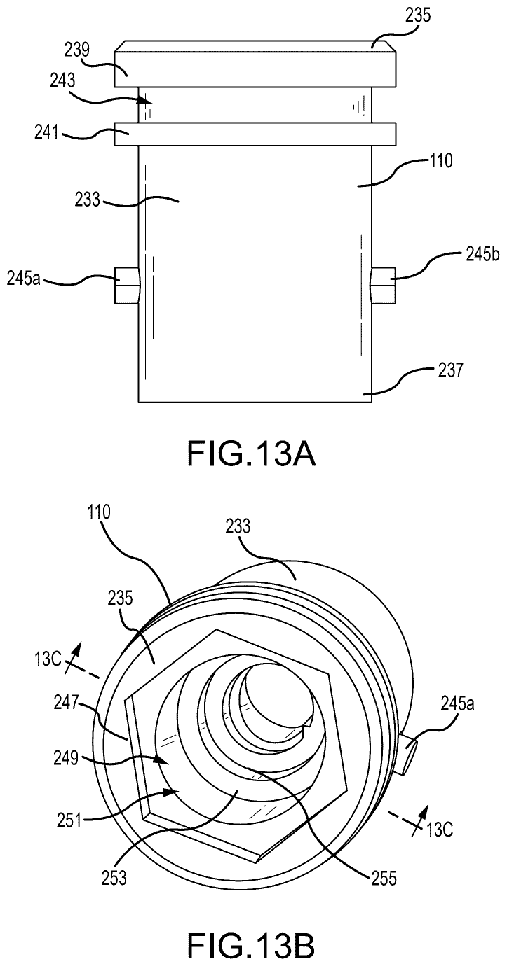

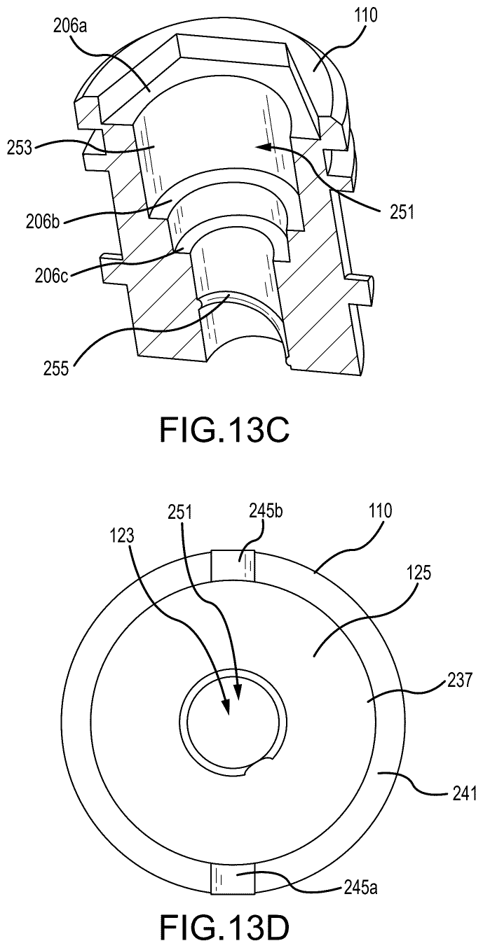

FIG. 13A is a front elevation view of the bottom housing 110 of the self-stabilizing screwdriver 100 of FIG. 1. FIG. 13B is a top isometric view of the bottom housing 110 of FIG. 13A. FIG. 13C is a top isometric cross-section view of the bottom housing of FIG. 13B taken along line 13C-13C. FIG. 13D is a bottom plan view of the bottom housing 110 of FIG. 13A. The bottom housing 110 may have a cylindrical body 233. The cylindrical body 233 may have a first or top end 235 and a second or bottom end 237. The top end 235 may include a first or top ring 239 and a second or bottom ring 241. A circumferential recess or groove 243 may be defined between the top ring 239 and the bottom ring 241. One or more bosses may be positioned on opposing sides of the cylindrical body 233. In the present embodiment, two stabilizer coupling bosses 245a,b are depicted with a cylindrical shape; however, other numbers and shapes are contemplated (e.g., a rectangular shape).

The top end 235 may have a top surface 247 that defines a bottom housing top aperture 249. As shown, the bottom housing top aperture 249 has a hexagonal shape; however, other shapes are contemplated. The bottom housing top aperture 249 may provide access to a bottom housing cavity 251. The bottom housing cavity wall 253 surrounding the bottom housing cavity 251 may include a plurality of steps or ridges, for example a top ridge 206a, a middle ridge 206b, and a bottom ridge 206c, and a helical boss 255. The bottom end 237 may include a bit aperture 123 defined within a bottom surface 125 of the bottom housing 110. The bit aperture 123 may provide access to the bottom housing cavity 251.

FIG. 14A is a right side top isometric view of the stabilizer 105 of the self-stabilizing screwdriver 100 of FIG. 1. FIG. 14B is a left side top isometric view of the stabilizer 105 of FIG. 14A. As shown, the stabilizer 105 may include the plurality of legs 104 coupled to a stabilizer ring 257. The stabilizer ring 257 may define a stabilizer cavity 259. The stabilizer cavity wall or stabilizer ring inner surface 261 may surround the stabilizer cavity 259. One or more L-shaped recesses 263a,b may be defined within the stabilizer cavity wall or stabilizer ring inner surface 261. As shown, two L-shaped recesses 263a,b are on opposing sides of the stabilizer cavity wall or stabilizer ring inner surface 261. The L-shaped recesses 263 may face opposite directions. Other shapes of the recesses are contemplated. As an example, the recesses may be connected as a single recess. For example, the recess may be a groove that runs around the circumference of the stabilizer cavity wall 261.

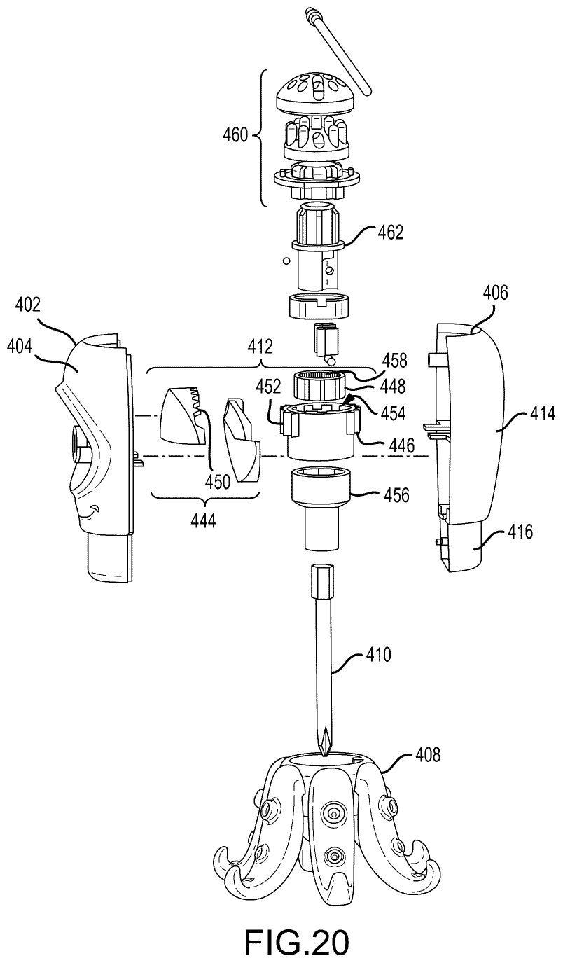

FIG. 15 is a cross-section view of the self-stabilizing screwdriver of FIG. 1 taken along line 15-15. As shown, in the assembled configuration, the thrust device 138, drive gear 146, ratchet device 142, screwdriver bit 106, bottom housing 110, and springs 140, 152 are all positioned at least partially within the housing cavity 103 defined by the top housing 108. The front top housing 191 and rear top housing 193 may be coupled together to form the top housing 108. Specifically, the housing coupling bosses 199a,b,c,d of the front top housing 191 may be aligned with and positioned within the coupling recesses 209a,b,c,d, respectively, of the rear top housing 193. The bottom housing 110 may be rotably or movably coupled to the top housing 108. In some embodiments, the bottom housing 110 is fixedly coupled to the top housing 108. The bottom housing 110 may be positioned such that the bottom ring 241 fits inside the curved recess 201 of the front top housing 191 and is positioned on top of the step 213b of the rear top housing 193. While the bottom housing 110 is depicted as a separate component from the top housing 108, it is contemplated that the housing components may be a single, unitary housing component (e.g., fused together or formed from the same molding) (e.g., as depicted in the embodiment in FIGS. 20-24).

The stabilizer 105 may be coupled to the bottom housing 110. The stabilizer 105 may be coupled to the bottom housing 110 by a bayonet connector. The stabilizer coupling bosses 245a,b of the bottom housing 110 may be positioned inside the L-shaped recesses 263a,b of the stabilizer 105. The stabilizer coupling bosses 245a,b may be inserted into the vertical segments of the L-shaped recesses 263a,b and the stabilizer 105 may be rotated such that the stabilizer coupling bosses 245a,b are positioned at the end of the horizontal segments of the L-shaped recesses 263a,b so that they may maintain their positions and do no slide out of the vertical segments of the L-shaped recesses 263a,b. It is contemplated that the stabilizer 105 and/or bottom housing 110 are made of material(s) that result in an interference fit between the stabilizer coupling bosses 245a,b and the L-shaped recesses 263a,b. In embodiments where the L-shaped recesses 263a,b are omitted and instead the recess is a groove formed around the circumference of the stabilizer cavity wall 261, the groove may allow the bottom housing 110 to move or turn relative to the stabilizer 105 (e.g., while the stabilizer 105 remains in a fixed position). It is contemplated that the bottom housing 110 may include the one or more recesses (e.g., one or more L-shaped recesses or grooves) and the stabilizer 105 may include the one or more bosses, for example, as described with respect to the self-stabilizing screwdriver 400 of FIGS. 20-24, and the bottom housing 110 and stabilizer 105 may be coupled in a similar manner as described above. The bayonet connector may facilitate removal of the stabilizer from the housing by a child or elderly individual. While a bayonet connector is shown, other means of removably coupling the stabilizer 105 to the bottom housing 110 are contemplated. As one example of an alternate connecting mechanism, the bottom housing 110 or the stabilizer 105 may include one or more holes or apertures and the other component may include one or more spring-loaded pins that lock into the corresponding one or more holes or apertures. Other conventional coupling means are contemplated. It is also contemplated that the stabilizer 105 may be fixedly coupled to the bottom housing 110.

The activation button 122 may be positioned within a space formed between the front top housing 191 and rear top housing 193. The activation button 122 may be coupled to or biased against the thrust device 138. The hexagonal boss 121 of the activation button 122 may be positioned within the first aperture 221 of the thrust device 138. The hexagonal shape of the hexagonal boss 121 may match the hexagonal shape of the first aperture 221, creating a secure fit between the components. At least a portion of the thrust device 138 may be positioned within the central cavity 151 of the drive gear 146. The thrust device 138 may be positioned such that the bottom end 147 of the drive gear 146 is positioned above the concentric ring 227 of the thrust device 138. Specifically, the bottom teeth 157 on the bottom surface 153 of the bottom end 147 of the drive gear 146 may align with and couple to the plurality of ring teeth 229 on the top surface of the ring 227 of the thrust device 138. The coupling of the bottom teeth 157 with the ring teeth 229 may prevent the thrust device 138 from rotating relative to the drive gear 146.

The drive gear 146 and the thrust device 138 may be positioned at least partially inside the bottom housing cavity 251 of the bottom housing 110. The drive gear 146 may be positioned such that the bottom surface 153 of the drive gear 146 rests on top of the top ridge 206a of the bottom housing cavity wall 253. The shape of the bottom surface 153 may align with the shape of the bottom housing top aperture 249. In the depicted embodiment, both the bottom surface 153 and bottom housing top aperture 249 have a hexagonal shape, which may create a secure fit between the components, allowing the bottom housing 110 to rotate with the drive gear 146. The spring 140 may be coupled to the thrust device 138. The spring 140 may be positioned around the thrust device 138 under the ring 227 such that the spring 140 rests on top of the middle ridge 206b of the bottom housing cavity wall 253.

The thrust device 138 may be coupled to or biased against the screwdriver bit 106. For example, the thrust device 138 may be biased against the shank 116. The screwdriver bit 106 may be positioned at least partially inside the thrust device 138. As shown, the shank 116 is positioned at least partially within the second end 219 of the thrust device 138. Specifically, the hexagonal shape of the shank 116 may align with the hexagonal shape of the second aperture 223 of the thrust device 138, maintaining the coupling between the screwdriver bit 106 and the thrust device 138. The helical channel or groove 231 of the body 118 of the screwdriver bit 106 may align with the helical boss 255 of the bottom housing cavity wall 253 and the helical boss 255 may be positioned inside the helical channel or groove 231, maintaining the screwdriver bit 106 in a desired vertical position. The tip 120 and/or body 118 of the screwdriver bit 106 may extend at least partially through the bit aperture 123 defined within the bottom surface 125 of the bottom housing 110.

The ratchet device 142 may be positioned inside the housing cavity 103 such that the ratchet activator 124 is positioned within the front top housing aperture 197 and the housing central boss 211 of the rear top housing 193 is positioned within the central aperture 185 of the ratchet central boss 183 of the ratchet device 142. The ratchet device 142 may be positioned such that the locking boss 148 is positioned within one of the notches 205a,b,c of the front top housing 191. The thrust device 138 and drive gear 146 may be positioned at least partially within the ratchet cavity 167 and between the ratchet front wall 159 and ratchet rear wall 165. The spring 152 may be positioned within the circular recess 181 defined in the ratchet rear wall rear surface 173 and may surround the ratchet central boss 183 and the housing central boss 211.

The ratchet device 142, drive gear 146, and spring 152 may form a ratchet system 144. FIG. 16 is a top plan view of an exemplary ratchet system 144 of the self-stabilizing screwdriver of FIG. 1. As shown, the gear teeth 154 engage with the ratchet teeth 150. In the depicted configuration, the central ratchet tooth 150c is positioned within a gap between gear teeth 154. The flat surface 177 of the central ratchet tooth 150c is positioned against the spacing surface 154d of the drive gear 146. Different configurations are contemplated as the ratchet device 142 moves relative to the drive gear 146, as discussed in more detail below. In some embodiments, the ratchet system 144 may be omitted. For example, the self-stabilizing screwdriver 100 may be operated as a screwdriver.

FIG. 17 is a bottom isometric view of another embodiment of a self-stabilizing screwdriver 160. The self-stabilizing screwdriver 160 has the same features as the self-stabilizing screwdriver 100 depicted in FIGS. 1-6, but has eight legs 162 instead of six legs 104. The self-stabilizing screwdriver 160 includes a housing 164 with a top housing 166 and a bottom housing (not shown). The bottom housing may include a base 168 that defines a bit aperture 170. The screwdriver bit 172 may be positioned within the bit aperture 170. The bit aperture 170 may allow the screwdriver bit 172 to pass therethrough when the self-stabilizing screwdriver 160 is in operation. The base 168 may include a light 187. The light 187 may be an LED light as one example. In the depicted embodiment, the light 187 forms a ring around the bit aperture 170 and surrounds the screwdriver bit 172. The light 187 may facilitate visibility while the self-stabilizing screwdriver 160 is in operation. For example, it may be easier for a user to see grooves in a screw when positioning the screwdriver bit 172 in line with the screw.

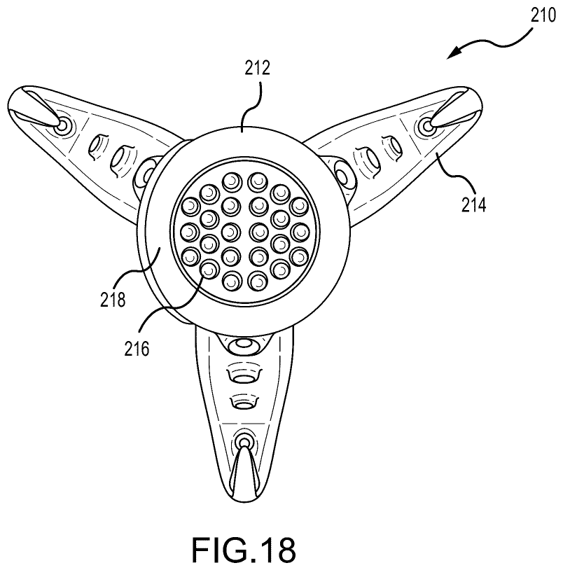

FIG. 18 is a top plan view of another embodiment of a self-stabilizing screwdriver 210. The self-stabilizing screwdriver 210 may have the same features as the self-stabilizing screwdriver 100 depicted in FIGS. 1-6, but with three legs 214 instead of six legs 104. For example, as shown, the self-stabilizing screwdriver 210 includes a housing 212. The housing 212 may include a top housing and a bottom housing or may be a unitary housing. The three legs 214 may be flexibly or rotably coupled to the housing 212, for example, to the bottom housing. The housing 212 may include a top surface 218. An activation button 216 may be coupled to the top surface 218 or may be omitted, as discussed further with respect to the self-stabilizing screwdriver 100 of FIGS. 1-6. The three legs 214 may provide similar stability to the self-stabilizing screwdriver 210 as the six legs 104 described with respect to the self-stabilizing screwdriver 100 of FIGS. 1-6. For example, the three legs 214 may act as a tripod to hold the self-stabilizing screwdriver 210 upright vertically from a surface. When the self-stabilizing screwdriver 210 is in operation, the three legs 214 may function in a similar manner as described with respect to the six legs 104 of the self-stabilizing screwdriver 100 of FIGS. 1-6. The three legs 214 may provide increased visibility of the screwdriver bit with less legs blocking the screwdriver bit from view.

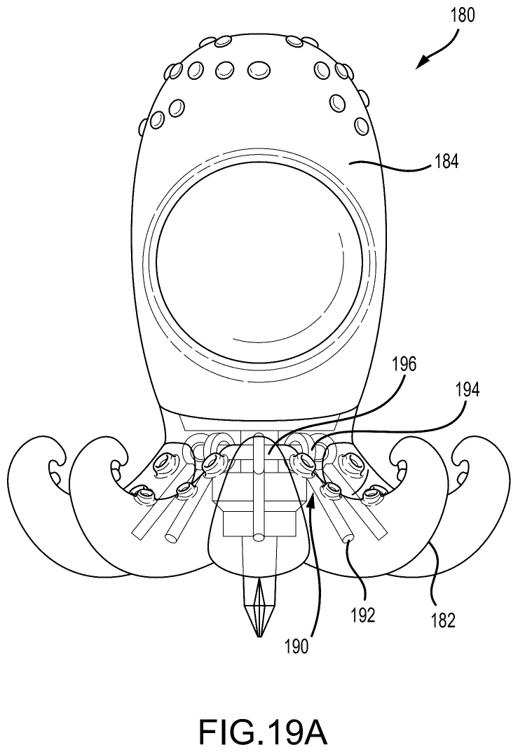

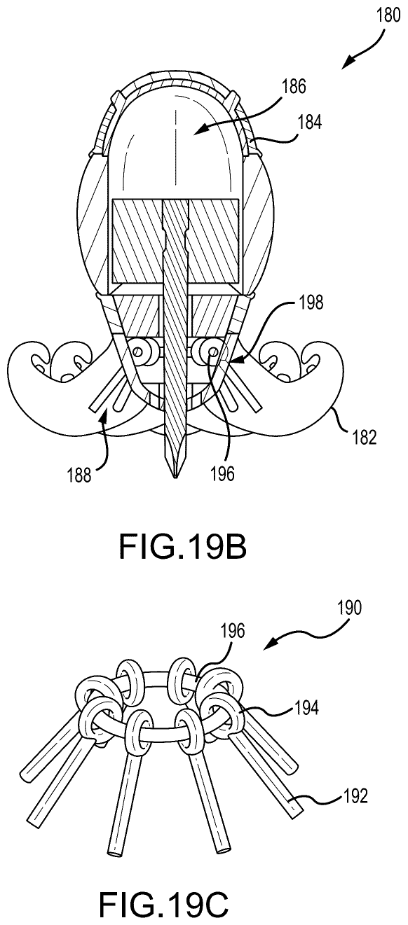

FIGS. 19A-C depict another embodiment of a self-stabilizing screwdriver 180. The self-stabilizing screwdriver 180 may include the same features as the self-stabilizing screwdriver 100 of FIGS. 1-6. In this embodiment, the self-stabilizing screwdriver 180 may include a plurality of legs 182 that are hingedly coupled to a housing 184 of the self-stabilizing screwdriver 180. The housing 184 may include a housing cavity 186. The legs 182 may define leg cavities 188. The legs 182 may include leg joints 190 that enable the legs 182 to move relative to the housing 184. A leg joint 190 may include a shaft or linear body 192 with a loop 194 at one end. The linear body 192 may be positioned within the leg cavity 188. The loop 194 may be looped around a ring 196. As shown the ring 196 is positioned within the housing cavity 186 and may form a concentric circle with the outer housing 184. The ring 196 may surround a ratchet device positioned inside the housing cavity 186, similar to the ratchet device 142 of FIG. 7. The loop 194 may pass through a housing aperture 198 defined within the housing 184. The housing aperture 198 may limit the movement of the leg joint 190. The loop 194 may rotate relative to the ring 196, thereby moving the respective leg. It is contemplated that the legs 182 may be an extension of the housing 184 such that the housing cavity 186 and leg cavities 188 are part of the same cavity. In these embodiments, the housing aperture 198 is omitted. Other conventional leg joints are contemplated that facilitate movement of the legs relative to the housing, such as, for example, ball-and-socket joints.

In operation, the stabilizer 105, specifically the legs 104, stabilize the self-stabilizing screwdriver 100 in a position perpendicular to a surface, and prevent lateral movement or wobbling of the self-stabilizing screwdriver 100 as it is used to screw in a screw. The legs 104 may spread out along the surface as the screwdriver bit 106 rotates to screw in the screw. By maintaining contact with the surface as the self-stabilizing screwdriver 100 is in operation, stabilization is maintained throughout operation. By holding the self-stabilizing screwdriver 100 in a perpendicular position, the stabilizer 105 or legs 104 may improve placement of the screw in a position perpendicular to the surface, avoiding screwing the screw at unwanted angles.

The screwdriver bit 106 may be in a retracted position when the self-stabilizing screwdriver 100 is not in use. For example, in the retracted position, the screwdriver bit 106 may be stored within or partially within the housing cavity 103 or the bottom housing cavity 251. The screwdriver bit 106 may be positioned in an engaged position during use. For example, in the engaged position, the screwdriver bit 106 may be positioned at least partially outside the housing cavity 103 or the bottom housing cavity 251. For example, the screwdriver bit 106 may be positioned such that the tip 120 is flush with the bottom surface 114 of the legs 104.

In several embodiments, to engage the screwdriver bit 106, the activation button 122 is engaged by a user pushing the activation button 122, which pushes the thrust device 138 into the screwdriver bit 106, pushing the screwdriver bit 106 through the bit aperture 123 and at least partially outside the housing cavity 103. The activation button 122 may push the thrust device 138 down into the spring 140, compressing the spring 140 and disengaging the thrust device 138 from the drive gear 146, specifically disengaging the ring teeth 229 of the thrust device 138 from the bottom teeth 157 of the drive gear 146. When disengaged, the thrust device 138 may turn relative to the drive gear 146 by turning of the activation button 122 in a clockwise or counterclockwise direction. Turning of the thrust device 138, e.g., in the clockwise direction, may turn the screwdriver bit 106. As the screwdriver bit 106 turns, it moves along the helical boss 255 of the bottom housing cavity wall 253 and downward out the bit aperture 123. When the activation button 122 is released, the spring 140 may return to its original position, pushing the thrust device 138 upward such that the ring teeth 229 of the thrust device 138 re-engage the bottom teeth 157 of the drive gear 146, preventing the thrust device 138 and screwdriver bit 106 from rotating relative to the drive gear 146.

When engaged, the screwdriver bit 106 may not extend past the legs 104 for improved safety, e.g., so a user does not get stabbed by the tip 120. The legs 104 may thereby protect a user, particularly a child, from injury. The distance that the screwdriver bit 106 extends out the bit aperture 123 may be limited by the movement of the thrust device 138. The movement of the thrust device 138 may be restricted by contacting with the bottom ridge 206c of the bottom housing cavity wall 253.

The activation button 122 may be pushed again to disengage the screwdriver bit 106, such that the screwdriver bit 106 is retracted through the bit aperture and repositioned inside of the housing cavity 103. For example, the activation button 122 may be pressed and turned in the opposite direction, turning the thrust device 138 and screwdriver bit 106 in the opposite direction, e.g., in the counterclockwise direction, and moving the screwdriver bit 106 in an opposite direction along the helical boss 255 of the bottom housing cavity wall 253, upwards through the bit aperture 123, and back into the bottom housing cavity 251. It is contemplated that the activation button 122 may be omitted and the screwdriver bit 106 may be in an engaged position when the self-stabilizing screwdriver 100 is not in use. In these embodiments, the thrust device 138 and spring 140 may also be omitted. For example, the screwdriver bit 106 may be coupled to one or more of the ratchet device 142, the drive gear 146, and the housing 102.

To lock or activate or unlock or deactivate the ratchet function of the self-stabilizing screwdriver 100, the ratchet activator 124 may be reoriented, e.g., pushed, turned/rotated, or both. When the ratchet activator 124 is pushed or engaged, the ratchet rear wall 165 may compress the spring 152, the housing central boss 211 of the rear top housing 193 may be positioned further within the central aperture 185 of the ratchet central boss 183 of the ratchet device 142, the locking boss 148 may move out of one of the notches 205a,b,c of the front top housing 191, and the ratchet teeth 150a,b,c may disengage the gear teeth 154. With the ratchet activator 124 in the engaged position, the ratchet device 142 may be turned in a clockwise or counterclockwise position by turning the ratchet activator 124. For example, turning the ratchet device 142 counterclockwise may move the locking boss 148 from the first outer notch 205a to the central notch 205b or to the second outer notch 205c, depending on the degrees of rotation, or from the central notch 205b to the second outer notch 205c. Turning the ratchet device 142 clockwise may move the locking boss 148 from the second outer notch 205c to the central notch 205b or to the first outer notch 205a, depending on the degrees of rotation, or from the central notch 205b to the first outer notch 205a.

Rotating the ratchet activator 124 and ratchet device 142 may reposition the ratchet teeth 150a,b,c relative to the gear teeth 154. For example, turning the ratchet device 142 counterclockwise may disengage the first outer ratchet tooth 150a or the central ratchet tooth 150c from the gear teeth 154, depending on which ratchet tooth 150a,c is engaged, and engage the central ratchet tooth 150c or second outer ratchet tooth 150b with the gear teeth 154, depending on the degrees of rotation. Turning the ratchet device 142 clockwise may disengage the second outer ratchet tooth 150b or the central ratchet tooth 150c from the gear teeth 154, depending on which ratchet tooth 150b,c is engaged, and engage the central ratchet tooth 150c or first outer ratchet tooth 150a with the gear teeth 154, depending on the degrees of rotation. The degrees of rotation may depend on the distance between the ratchet teeth 150a,b,c. As one example, the degrees of rotation to rotate between adjacent ratchet teeth 150a,b,c may be 17 degrees and 34 degrees to rotate between the outer ratchet teeth 150a,b; however, other degrees of rotation are contemplated.

The position of the ratchet teeth 150a,b,c relative to the gear teeth 154 may depend on the location of the locking boss 148 relative to the notches 205a,b,c. For example, when the locking boss 148 is positioned within the first outer notch 205a, the first outer ratchet tooth 150a may be engaged with or biased against the gear teeth 154. Specifically the sloped surface 175a may be biased against the first sloping side 154a of the gear teeth 154. When the locking boss 148 is positioned within the central notch 205b, the central ratchet tooth 150c may be engaged with or biased against the gear teeth 154. Specifically, the flat surface 177 may be engaged with or biased against the spacing surface 154d. When the locking boss 148 is positioned within the second outer notch 205c, the second outer ratchet tooth 150b may be engaged with or biased against the gear teeth 154. Specifically, the sloped surface 175b may be biased against the second sloping side 154b of the gear teeth 154.

When the ratchet device 142 is positioned in the desired location, the ratchet activator 124 may be released or disengaged, which allows the spring 152 to return to its original expanded state, pushing the ratchet device 142 towards the front top housing 191, moving the housing central boss 211 out of or at least partially out of the central aperture 185, reengaging the ratchet teeth 150a,b,c with the gear teeth 154, and positioning the locking boss 148 within one of the notches 205a,b,c. The positioning of the locking boss 148 within one of the notches 205a,b,c may lock the ratchet device 142 in place, keeping the ratchet device 142 in a particular state.

Rotation of the housing 102 may rotate the ratchet device 142. Depending on the ratchet teeth 150a,b,c that are engaged with the gear teeth 154, the drive gear 146 may rotate with the rotation of the ratchet device 142 or may remain still as the ratchet device 142 rotates around it. The rotation of the drive gear 146 may rotate the bottom housing 110 and the screwdriver bit 106 positioned therein.

When the locking boss 148 is positioned in the central notch 205b and the central ratchet tooth 150c engages the gear teeth 154, the ratchet system 144 may be in a locked or deactivated state and the self-stabilizing screwdriver 100 may be in a screwdriver state. In the locked or deactivated state, the ratchet device 142 and drive gear 146 may be locked together and may rotate together, for example as the housing 102 is rotated. For example, the flat surface 177 of the central ratchet tooth 150c may maintain its engagement with the spacing surface 154d of the gear teeth 154 as the ratchet device 142 is rotated, thereby rotating the drive gear 146. In the screwdriver state, the self-stabilizing screwdriver 100 functions as a conventional screwdriver, e.g., turning the self-stabilizing screwdriver 100 clockwise tightens a screw and turning it counterclockwise loosens a screw.

When the locking boss 148 is positioned within the first outer notch 205a or the second outer notch 205c and the first outer ratchet tooth 150a or the second outer ratchet tooth 150b are engaged with the gear teeth 154, the ratchet system 144 may be in an unlocked or activated state and the self-stabilizing screwdriver 100 may be in a ratchet state. In the ratchet state, the ratchet device 142 may move relative to the drive gear 146 when the ratchet device 142 is rotated in one direction and may rotate the drive gear 146 when the ratchet device 142 is rotated in the other direction.

When the locking boss 148 is positioned within the second outer notch 205c and the second outer ratchet tooth 150b is engaged with the gear teeth 154, the ratchet system 144 may be in a tightening ratchet state. In the tightening ratchet state, the ratchet device 142 may rotate around the drive gear 146 in a counterclockwise direction without moving the drive gear 146. When the ratchet device 142 is rotated in a clockwise direction, the ratchet device 142 may rotate the drive gear 146 in the clockwise direction, thereby rotating the bottom housing 110 and the screwdriver bit 106 in the clockwise direction to tighten a screw. Specifically, when the ratchet device 142 is rotated in a counterclockwise direction, the sloped surface 175b may slide against the second sloping side 154b of the gear teeth 154 and reposition into a different gap between gear teeth 154. The ratchet device 142 may push against the spring 152 to reposition the second outer ratchet tooth 150b in the adjacent gap between gear teeth 154. The gear teeth 154 may remain in the same position as no force is applied to the gear teeth 154. When the ratchet device 142 is rotated in a clockwise direction, the second outer ratchet tooth 150b may catch an adjacent gear tooth 154, specifically, the first sloping side 154a of the gear teeth 154, which is sloped in a direction opposing the sloped surface 175b. The second outer ratchet tooth 150b may apply force to the gear teeth 154, rotating the gear teeth 154 in the same direction as the ratchet device 142, i.e., in the clockwise direction.

When the locking boss 148 is positioned within the first outer notch 205a and the first outer ratchet tooth 150a is engaged with the gear teeth 154, the ratchet system 144 may be in a loosening ratchet state. In the loosening ratchet state, the ratchet device 142 may rotate around the drive gear 146 in a clockwise direction without moving the drive gear 146. When the ratchet device 142 is rotated in a counterclockwise direction, the ratchet device 142 may rotate the drive gear 146 in the counterclockwise direction, thereby rotating the bottom housing 110 and the screwdriver bit 106 in the counterclockwise direction to loosen a screw. Specifically, when the ratchet device 142 is rotated in a clockwise direction, the sloped surface 175a may slide against the first sloping side 154a of the gear teeth 154 and reposition into a different gap between gear teeth 154. The ratchet device 142 may push against the spring 152 to reposition the first outer ratchet tooth 150a in the adjacent gap between gear teeth 154. The gear teeth 154 may remain in the same position as no force is applied to the gear teeth 154. When the ratchet device 142 is rotated in a counterclockwise direction, the first outer ratchet tooth 150a may catch an adjacent gear tooth 154, specifically, the second sloping side 154b of the gear teeth 154, which is sloped in a direction opposing the sloped surface 175a. The first outer ratchet tooth 150a may apply force to the gear teeth 154, rotating the gear teeth 154 in the same direction as the ratchet device 142, i.e., in the counterclockwise direction.

While a particular embodiment of a ratchet device 142 and ratchet system 144 is shown, it is contemplated that other conventional ratchet mechanisms may be integrated into a disclosed self-stabilizing screwdriver to perform the ratchet function. For example, a conventional ratchet system may include a ratchet housing, a drive gear, a cam, a left pawl and a right pawl, and a left spring and a right spring. The drive gear may include a plurality of gear teeth. The left pawl and right pawl may include a plurality of pawl teeth. The screwdriver bit 106 may be positioned within an aperture of the drive gear and/or may be coupled to the drive gear. In some embodiments, the ratchet activator may be engaged or disengaged to change the operation state of a disclosed self-stabilizing screwdriver. For example, when engaged (e.g., by a user pushing or reorienting the ratchet activator), the ratchet operation state or function may be activated. In the ratchet state, the ratchet may be activated and may operate to turn the screwdriver bit 106. In some embodiments, the top housing 108 may be turned relative to the bottom housing 110. Turning the top housing 108 may turn the ratchet device the same direction. The ratchet housing may turn around the drive gear in one direction without moving the drive gear, and may engage with and turn the drive gear as the ratchet housing turns in the other direction, depending on which pawl is engaged. For example, when the pawl teeth engage with the gear teeth, they may assist in turning the drive gear. As the drive gear turns, the screwdriver bit 106 may turn in the same direction. When in the ratchet state, the top housing 108 may be turned while the bottom housing 110 and legs 104 remain stationary to drive the screwdriver bit 106 down into a screw. The top housing 108 may be turned repeatedly clockwise and counterclockwise to drive the screwdriver bit 106 into a screw and to screw in the screw, similar to how a conventional ratchet functions.

In some embodiments, the ratchet activator 124 may be disengaged to deactivate the ratchet function and activate the screwdriver operation state or function. In the screwdriver state, the top housing 108 may be turned in a clockwise direction to drive the screwdriver bit 106 into a screw and to screw in the screw or in a counterclockwise direction to remove a screw.

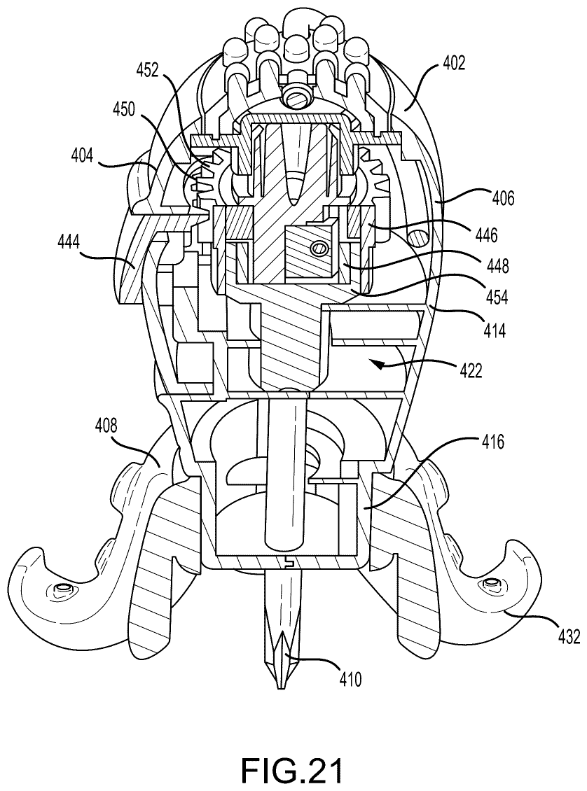

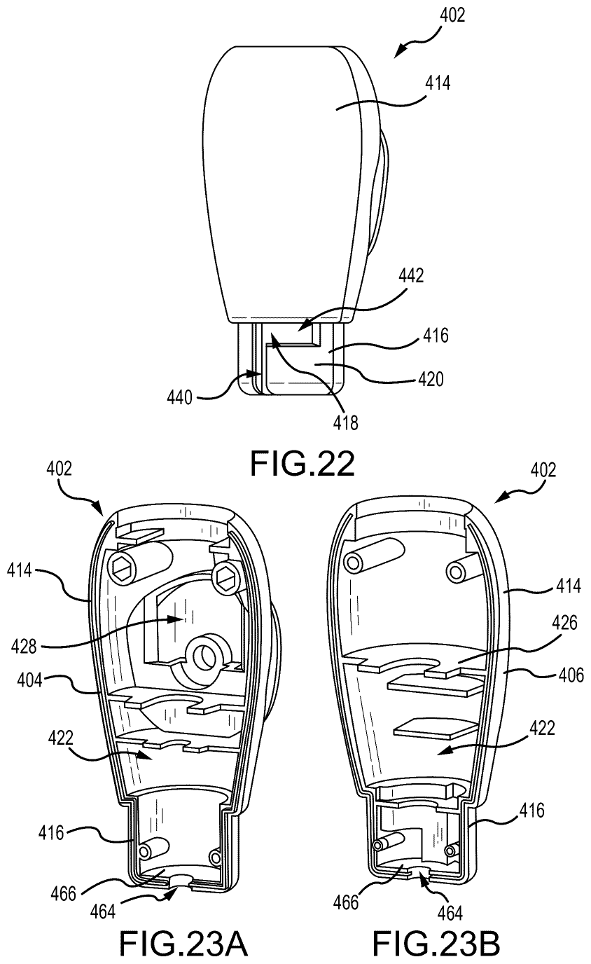

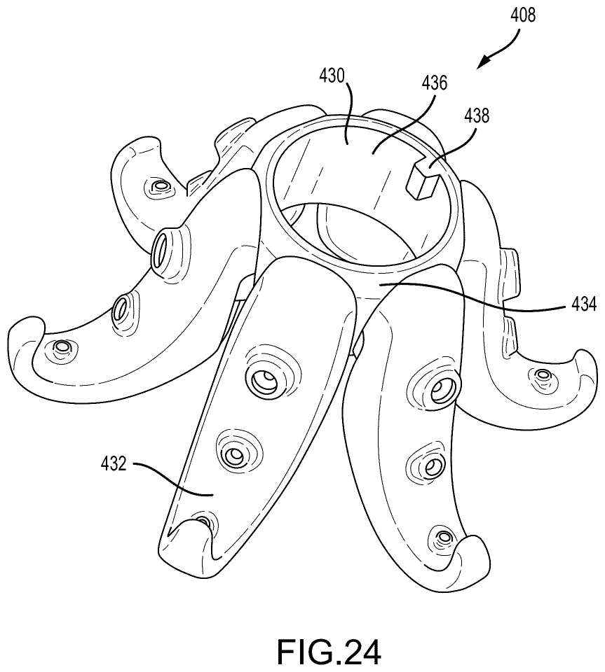

FIGS. 20-24 show another embodiment of a self-stabilizing screwdriver 400. FIG. 20 is an exploded view of the self-stabilizing screwdriver 400. The front and rear elevation views of the self-stabilizing screwdriver 400 in the assembled configuration are the same as the front and rear elevation views of the self-stabilizing screwdriver 100 in FIGS. 1 and 2. Such views are therefore omitted for simplicity. FIG. 21 is a cross-section view of the self-stabilizing screwdriver 400. The cross-section line 21-21 is depicted in FIG. 1 to show where the cross-section is taken on the self-stabilizing screwdriver 400. FIG. 22 is a rear perspective view of the housing 402 of the self-stabilizing screwdriver 400 of FIG. 20. FIG. 23A is a rear isometric view of the front housing 404 of the self-stabilizing screwdriver 400 of FIG. 20. FIG. 23B is a front isometric view of the rear housing 406 of the self-stabilizing screwdriver 400 of FIG. 20. FIG. 24 is a top isometric view of the stabilizer 408 of the self-stabilizing screwdriver 400 of FIG. 20. The self-stabilizing screwdriver 400 may have some of the same features or similar features as the self-stabilizing screwdriver 100 depicted in FIGS. 1-6. For example, as shown, the self-stabilizing screwdriver 400 may include a housing 402, a stabilizer 408, and a screwdriver bit 410.

Unless otherwise noted herein, the component parts of the self-stabilizing screwdriver 400 may have a similar or the same structure, may connect in the same manner with other parts, and may be made of the same materials as the component parts of the self-stabilizing screwdriver 100 of FIGS. 1-16. Further, the self-stabilizing screwdriver 400 and its component parts may function and may be modified in the same manner as described with respect to the self-stabilizing screwdriver 100. As shown in FIGS. 20-24, the self-stabilizing screwdriver 400 includes some component parts that differ from the self-stabilizing screwdriver 100 depicted in FIGS. 1-6. For example, the self-stabilizing screwdriver 400 includes at least a different housing 402, stabilizer 408, and ratchet system 412 from those of the self-stabilizing screwdriver 100. For example, the housing 402 may include a top housing 414 and a bottom housing 416 that are formed together as a single component. The top housing 414 may be referred to as a top portion of the housing 402 or a top housing portion and the bottom housing 416 may be referred to as a lower portion of the housing 402 or a bottom or lower housing portion. It is contemplated that the top housing 414 or top portion of the housing 402 and the bottom housing 416 or bottom portion of the housing 402 may be separate components. The top housing 414 may form a screwdriver body. The bottom housing 416 may be recessed from the top housing 414. The bottom housing 416 may form a housing ring below the screwdriver body. The bottom housing 416 may have a cylindrical shaped body. The bottom housing 416 may have a diameter that is smaller than the smallest diameter of the top housing 414. The bottom housing 416 may include one or more stabilizer coupling elements or features, for example, one or more recesses and/or bosses, that couple to the stabilizer 408. The one or more stabilizer coupling elements or features may be positioned on a bottom housing outer surface 420. It is contemplated that the coupling elements or features may be positioned on a bottom housing inner surface. As shown, the bottom housing 416 includes a bottom housing recess 418 on a bottom housing outer surface 420; however, other conventional coupling means are contemplated. In the depicted embodiment, the bottom housing recess 418 has an L-shape. The housing 402 may define a housing cavity 422.

The housing 402 may be made of a single component or multiple components. In the depicted embodiment, the housing 402 is made of two components, a front housing 404 and a rear housing 406 that are coupled together. The front housing 404 and rear housing 406 may have similar features to the front top housing 191 and the rear top housing 193 of the self-stabilizing screwdriver 100. For example, the front housing 404 and rear housing 406 may include coupling features 424, such as coupling recesses and bosses to couple the front housing 404 and rear housing 406 together. The front housing 404 and rear housing 406 may include one or more recesses, grooves, or steps 426 similar to the front top housing 191 and rear top housing 193 of the self-stabilizing screwdriver 100 to fit and/or hold in place one or more of the internal components of the self-stabilizing screwdriver 400 (e.g., one or more of the ratchet system 412 components). The front housing 404 may define a front housing aperture 428.

The stabilizer 408 may include a stabilizer ring 430 and a plurality of stabilizer elements or legs 432. The legs 432 may extend from the stabilizer ring 430. The legs 432 may extend outward from, be fused with, or otherwise coupled to a stabilizer outer surface 434 of the stabilizer ring 430. While six legs 432 are depicted, more or less legs 432 are contemplated, as discussed further above with respect to the embodiments depicted in FIGS. 1-18. The stabilizer ring 430 may include one or more stabilizer coupling elements or features on a stabilizer ring inner surface 436. It is contemplated that the one or more stabilizer coupling elements or features may be positioned on an outer surface of the stabilizer ring. In the depicted embodiment, the stabilizer coupling element is a stabilizer coupling boss 438 that extends outwards from the stabilizer ring inner surface 436. As shown, the stabilizer coupling boss 438 has a rectangular shape; however, other shapes are contemplated (e.g., a cylindrical shape). It is contemplated that the stabilizer coupling element may be another conventional type of coupling mechanism. For example, the stabilizer coupling element may be a recess, e.g., as described with respect to the stabilizer 105 of the self-stabilizing screwdriver 100 of FIGS. 1-16.

The stabilizer 408 may be removably coupled to the housing 402. For example, the stabilizer ring 430 may couple to the bottom housing 416. The stabilizer coupling boss 438 may be positioned inside the bottom housing recess 418. For example, a user may push the stabilizer coupling boss 438 up through the vertical portion 440 of the bottom housing recess 418 and then rotate the stabilizer 408 around the bottom housing 416 to move the stabilizer coupling boss 438 through the horizontal portion 442 of the bottom housing recess 418 until the stabilizer coupling boss 438 hits the end of the horizontal portion 442. The horizontal portion 442 may prevent vertical movement of the stabilizer 408 and may keep the stabilizer 408 in place on the housing 402. It is contemplated that the bottom housing outer surface 420 may include a boss in place of the L-shaped recess and that the stabilizer ring inner surface 436 may include an L-shaped recess in place of the stabilizer coupling boss 438 and that the bottom housing outer surface 420 boss may couple to the L-shaped recess of the stabilizer 408 (similar to the stabilizer 105 and bottom housing 110 of FIGS. 13A-14B). While a bayonet connector is shown, other means of removably coupling the stabilizer 408 to the bottom housing 402 are contemplated, such as a spring-loaded pin and hole, as described above, or other conventional coupling means.

The ratchet system 412 may be a conventional 60-tooth ratchet; however, the number of teeth may be varied as desired. The ratchet system 412 may include a ratchet device 444, a drive gear 446, and a ratchet ring 448. The ratchet device 444 may be made of one or more component parts. The ratchet device 444 may include a plurality of ratchet teeth 450. The ratchet device 444 may be positioned within the front housing aperture 428 and may be coupled to the front housing 404. A front surface of the ratchet device 444 may function as the ratchet activator, in a similar manner as described with respect to FIGS. 1-16. The drive gear 446 may include a plurality of gear teeth 452 that extend from an outer surface of the drive gear 446. The drive gear 446 may define a drive gear cavity 454. The drive gear 446 may be positioned within the housing cavity 422. The drive gear 446 may be positioned partially on one or more of the steps 426 of the front housing 404 and/or rear housing 406. The drive gear 446 may be coupled to the screwdriver bit 410 either directly or via an intermediary component 456. A portion of the intermediary component 456 may be positioned inside the drive gear cavity 454. The ratchet ring 448 may include a plurality of ratchet ring teeth 458 on an inner surface of the ratchet ring 448. The ratchet ring 448 may include 60 or more ratchet ring teeth 458; however, less teeth are also contemplated. The ratchet ring 448 may be positioned inside the drive gear cavity 454 of the drive gear 446. As shown, the ratchet ring 448 is positioned inside a cavity of a portion of the intermediary component 456 that is inside the drive gear cavity 454.

The ratchet teeth 450 of the ratchet device 444 may engage with the gear teeth 452 of the drive gear 446. The ratchet teeth 450 may engage with the gear teeth 452 in a similar manner as described with respect to the ratchet teeth 150a-c and the gear teeth 154 of the ratchet system 144 of FIG. 16 and the ratchet system 412 of FIGS. 20-24 may function in a similar manner as the ratchet system 144 of FIG. 16.

The self-stabilizing screwdriver 400 may include a top 460. The top 460 may be coupled to the ratchet system 412 by a cylindrical component 462. The cylindrical component 462 may couple to the top 460 and may extend at least partially inside the drive gear cavity 454. The ratchet ring 448 may surround a portion of the cylindrical component 462.

In some embodiments, the top 460 may engage the ratchet system 412. For example, instead of twisting the body to engage the ratchet system and turn the screwdriver bit 410, the top 460 may be turned or twisted to engage the ratchet system and turn the screwdriver bit 410.

In the embodiment of the self-stabilizing screwdriver 400 depicted in FIGS. 20-24, the activation button and thrust device are omitted and the screwdriver bit 410 remains in an engaged position, positioned through a housing aperture 464 defined in a base 466 of the housing 402 and partially outside the housing 402, surrounded by the stabilizer legs 432.

While a particular ratchet system 412 is depicted with the self-stabilizing screwdriver 400, it is contemplated that any conventional ratchet system may be included. It is also contemplated that the ratchet system 144 described with respect to FIGS. 1-16 may be included with the self-stabilizing screwdriver 400 of FIGS. 20-24. It is further contemplated that the ratchet system 412 may be omitted and the self-stabilizing screwdriver 400 may function as a conventional screwdriver, without the ratchet function.

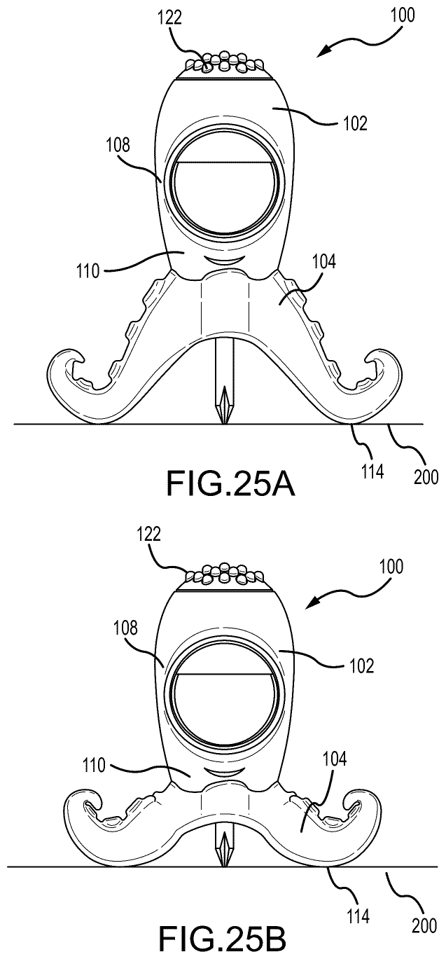

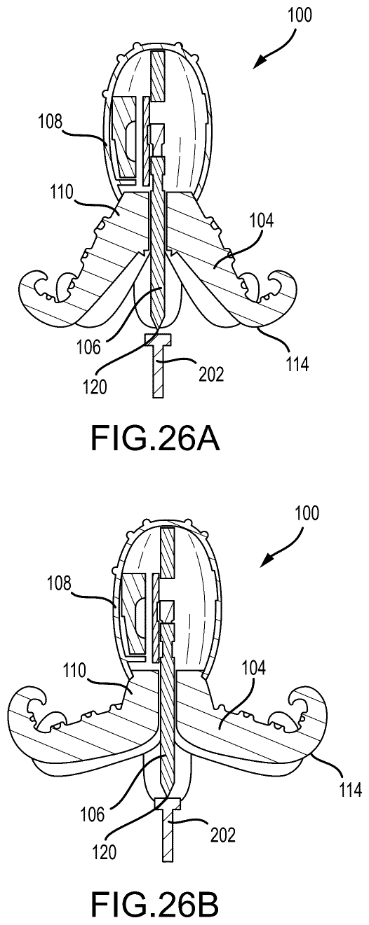

FIGS. 25A-26B are images of disclosed self-stabilizing screwdrivers in operation. For ease of reference, the same reference numbers are used as the self-stabilizing screwdriver 100 of FIG. 1; however, it is contemplated that these figures could show other disclosed self-stabilizing screwdrivers. FIGS. 25A and 26A show the self-stabilizing screwdriver 100 in a first position. FIGS. 25B and 26B show the self-stabilizing screwdriver 100 in a second position. In the first position, the self-stabilizing screwdriver 100 is in a preoperational state. In the preoperational state, the legs 104 are in a raised or retracted position and rest on the surface 200, holding the self-stabilizing screwdriver 100 in an upright position, perpendicular to the surface 200. Specifically, the bottom surface 114 of the legs 104 contacts the surface 200. In the retracted position, the legs 104 are in a more vertical position relative to the legs 104 in the extended position, as discussed below.

As shown, the screwdriver bit 106 is in an engaged position and is disposed at least partially outside of the housing cavity 103. The tip 120 may be flush with or in the same position as the bottom surface 114 of the legs 104 and touches the surface 200, as shown in FIG. 25A, or engages with a screw 202, as shown in FIG. 26A. It is also contemplated that the tip 120 may be positioned higher or retracted from the bottom surface 114 of the legs 104 such that the legs 104 engage with a surface surrounding the screw 202 as the tip 120 engages with the screw 202, for example when the screw 202 is raised above the surface. By having the tip 120 in the same position as the bottom surface 114 of the legs 104 or in a more retracted position further from the surface, the self-stabilizing screwdriver 100 may maintain its stability by maintaining contact between the legs 104 and the surface 200.

In the second position, as shown in FIGS. 25B and 26B, the self-stabilizing screwdriver 100 is in an operational state. The operational state may be activated by turning the top housing 108 relative to the bottom housing 110, or turning both the top and bottom housing 108, 110, which turns the screwdriver bit 106 down into the screw 202, driving the screw 202 into the surface or object below. As the screwdriver bit 106 drives down into the screw 202, the screw 202 is lowered closer to the surface or object, and the legs 104 spread out along the surface. In some embodiments, a downward force exerted on the self- stabilizing screwdriver 100 may cause the legs 104 to spread out or slide along the surface. For example, a downward force may be exerted on the self-stabilizing screwdriver 100 as the self-stabilizing screwdriver 100 is turned to install the screw 202. In this operational state, the legs 104 are in an extended or spread out position. In the extended position, the legs 104 are in a more horizontal position relative to the legs 104 in the retracted position. The bottom surface 114 may continue to rest on the surface 200 below as the legs 104 spread out, thereby stabilizing the self-stabilizing screwdriver 100 as it is in operation.

In some embodiments, the legs 104 may return to the retracted state when the self-stabilizing screwdriver 100 is removed from the surface. For example, the legs 104 may be made of a flexible material that retracts when pressure is removed. In some embodiments, the legs 104 may retain the extended orientation until a user repositions them into the retracted state. In some embodiments, the self-stabilizing screwdriver 100 may include a button that moves the legs 104 back to a retracted state. In some embodiments, the legs 104 may be positioned into a stored state. For example, the legs 104 may be positioned manually or via a button into the stored state. In the stored state, the legs 104 may come closer together than is depicted in the preoperational state, e.g., as shown in FIGS. 25A and 26A. For example, in the stored state, the legs 104 may contact the screwdriver bit 106 or, if the screwdriver bit 106 is inside the housing cavity 103, the legs 104 may come in contact with one another or may be in close proximity to one another. In the stored state, the legs 104 may be more vertically aligned with the housing 102. In this stored state, it may be easier to store the self-stabilizing screwdriver 100.

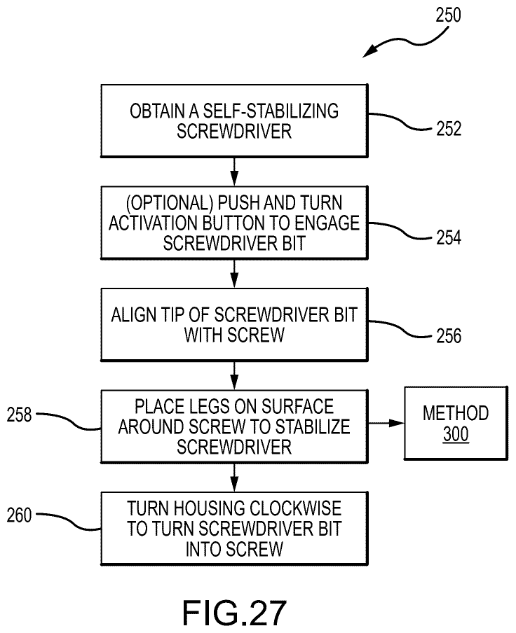

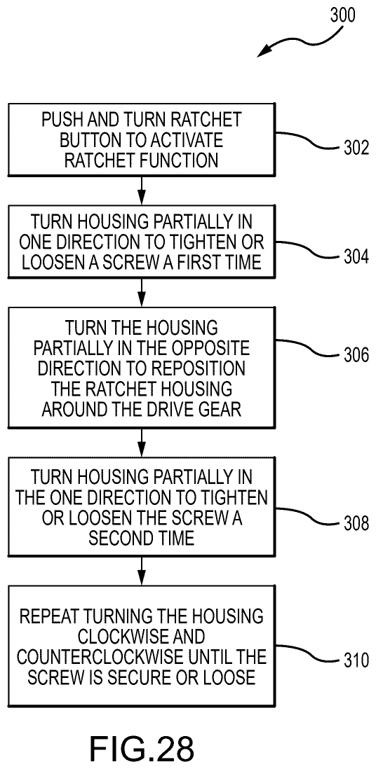

FIGS. 27 and 28 are flowcharts illustrating methods of using disclosed self-stabilizing screwdrivers. FIG. 27 is a flow chart illustrating a method of using a disclosed self-stabilizing screwdriver. The method 250 begins with operation 252 and a self-stabilizing screwdriver is obtained by a user. The self-stabilizing screwdriver may be a self-stabilizing screwdriver 100, 160, 180, 210 described with respect to FIGS. 1-26B.

After operation 252, the method 250 may optionally proceed to operation 254 and an activation button on a top surface of the housing may be pressed, pushed, selected, or activated and turned to engage the screwdriver bit or reposition the screwdriver bit at least partially outside the housing cavity. For example, as discussed above with respect to the self-stabilizing screwdriver 100, pushing the activation button 122 may disengage the thrust device 138 from the drive gear 146, allowing the thrust device 138 to turn relative to the drive gear 146 by turning of the activation button 122 in a clockwise direction, which turns the screwdriver bit 106 down along the helical boss 255 of the bottom housing cavity wall 253 and downward out the bit aperture 123. In some embodiments, turning may be omitted and pushing the activation button may engage the screwdriver bit. Operation 254 may be omitted, for example, if the activation button is omitted and/or the screwdriver bit is already in an engaged position.

After operation 252, or optionally after operation 254, the method 250 may proceed to operation 256 and the screwdriver bit tip may be aligned with a screw on a surface. For example, the tip may align with a slit or slits in a screw. In embodiments where the tip includes a magnet, the magnet may facilitate such alignment.

After operation 256, the method 250 may proceed to operation 258 and the legs of the self-stabilizing screwdriver may be placed on the surface around the screw to stabilize the self-stabilizing screwdriver when it is in operation.

After operation 256, the method 250 may proceed to operation 260 and the housing of the self-stabilizing screwdriver may be turned in a clockwise direction to turn the screwdriver bit into the screw. As the screwdriver bit is turned into the screw, moving the screw closer to the surface, the legs may spread out along the surface to retain stability.

In some embodiments, after operation 256, the method 250 may proceed to method 300 and a ratchet function may be activated prior to rotating the screwdriver bit. FIG. 28 is a flowchart illustrating a method 300 of using a ratchet function of a disclosed self-stabilizing screwdriver. The method 300 begins with operation 302 and the ratchet function of the self-stabilizing screwdriver may be activated by pressing a ratchet button on a side of the housing. The ratchet button may engage or activate a ratchet positioned inside the housing cavity of the self-stabilizing screwdriver. For example, the ratchet may be the ratchet 142 described with respect to FIGS. 6, 9A-C, and 15. With the ratchet 142 depicted in FIGS. 6, 9A-C, and 15, operation 302 may include turning the ratchet button 123 after pressing the ratchet button 123. For example, the ratchet button 123 may be turned in a clockwise direction to engage the first outer ratchet tooth 150a with the gear teeth 154, placing the ratchet system 144 in a loosening ratchet state. The ratchet button 123 may be turned in a counterclockwise direction to engage the second outer ratchet tooth 150b with the gear teeth 154, placing the ratchet system 144 may be in a tightening ratchet state.

After operation 302, the method 300 may proceed to operation 304 and the housing may be turned in one direction to tighten or loosen a screw a first time. In the tightening ratchet state, the housing may be turned clockwise to tighten the screw a first time. In the loosening ratchet state, the housing may be turned counterclockwise to loosen the screw a first time. For example, the top housing 108 may be turned, which turns the ratchet 142 and the drive gear 146 due to the engagement between the gear teeth 154 and one of the outer ratchet teeth 150a,b. Turning the drive gear 146 may turn the screwdriver bit 106 that is coupled to the drive gear 146. In some embodiments, turning the top housing 108 may turn the bottom housing 110 relative to the legs 104 that remain in place as the top housing 108 and screwdriver bit 106 rotate. In some embodiments, the legs 104 may rotate with the bottom housing 110.

After operation 304, the method 300 may proceed to operation 306 and the housing may be turned in the opposite direction to reposition the ratchet housing around the drive gear. In the tightening state, the housing may be turned counterclockwise to reposition the ratchet housing around the drive gear. In the loosening state, the housing may be turned clockwise to reposition the ratchet housing around the drive gear.

After operation 306, the method 300 may proceed to operation 308 and the housing may again be turned partially in the same initial direction to tighten or loosen the screw a second time. The housing may turn in a similar manner as discussed above, e.g., clockwise to tighten in the tightening ratchet state or counterclockwise to loosen in the loosening ratchet state.

After operation 308, the method 300 may proceed to operation 310 and the clockwise and counterclockwise rotations of the housing may be repeated until the screw is secure or loose.

While disclosed self-stabilizing screwdrivers include screwdriver bits, it is contemplated that the self-stabilizing screwdriver may exclude a screwdriver bit and act as a screwdriver bit holder and stabilizer, with the screwdriver bit holder and stabilizer allowing for insertion of a screwdriver bit. For example, the screwdriver bit may be inserted into the screwdriver bit holder and stabilizer through the bit aperture on a bottom surface or base of the housing. In some embodiments, the top surface of the housing (e.g., top surface 126 of FIG. 1) may be removable (e.g., via a screw top) to insert the screwdriver bit inside of the screwdriver bit holder and stabilizer.

While much of the above description describes operating a disclosed self-stabilizing screwdriver to screw in or drive in a screw, it is contemplated that the same or similar operation of the disclosed self-stabilizing screwdriver may be used to unscrew or remove a screw (for example, by turning the self-stabilizing screwdriver in the opposite direction).

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements, relative movement between elements, and two or more members touching (e.g., one member biased against another or adjacent to another) unless otherwise indicated and may include wired or wireless connections, including electrical connections. As such, connection references do not necessarily infer that two elements are directly connected and in fixed relation to each other. The exemplary drawings are for purposes of illustration only and the dimensions, positions, order, and relative sizes reflected in the drawings attached hereto may vary.

While certain orders of operations are provided for methods disclosed herein, it is contemplated that the operations may be performed in any order and that operations can be omitted, unless specified otherwise.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

We claim:

1. A self-stabilizing screwdriver, comprising:
a housing defining a housing cavity, wherein the housing comprises a base;
a screwdriver bit extending from the base such that at least a portion of the screwdriver bit is positioned outside the housing; and
a stabilizer coupled to a lower portion of the housing, wherein the stabilizer surrounds the portion of the screwdriver bit positioned outside the housing, wherein the stabilizer is configured to hold the self-stabilizing screwdriver in an upright position such that the screwdriver bit is perpendicular to a surface when the self-stabilizing screwdriver is not in use, and wherein the stabilizer comprises a bottom surface configured to engage with the surface and to reduce lateral movement of the self-stabilizing screwdriver when the self-stabilizing screwdriver is in use.

2. The self-stabilizing screwdriver of claim 1, wherein the bottom surface is further configured to slide along the surface in a direction away from the screwdriver bit when the self-stabilizing screwdriver is in use.

3. The self-stabilizing screwdriver of claim 1, wherein the stabilizer comprises a plurality of stabilizer legs.

4. The self-stabilizing screwdriver of claim 3, wherein the plurality of stabilizer legs are coupled to the lower portion of the housing by a bayonet connection.

5. The self-stabilizing screwdriver of claim 3, wherein the stabilizer further comprises a stabilizer ring coupled to the lower portion of the housing, wherein the plurality of stabilizer legs are coupled to the stabilizer ring.

6. The self-stabilizing screwdriver of claim 5, wherein the stabilizer ring comprises one or more stabilizer coupling elements on a stabilizer ring inner surface and the lower portion of the housing comprises one or more stabilizer coupling features on an outer surface of the lower portion of the housing, and wherein the one or more stabilizer coupling elements are coupled to the one or more stabilizer coupling features to couple the stabilizer ring inner surface to the outer surface of the lower portion of the housing.

7. The self-stabilizing screwdriver of claim 5, wherein one of the stabilizer ring and the lower portion of the housing comprises an L-shaped recess defined in a surface and one of the stabilizer ring and the lower portion of the housing comprises a coupling boss, wherein the coupling boss slides into the L-shaped recess to couple the stabilizer ring to the lower portion of the housing.

8. The self-stabilizing screwdriver of claim 3, wherein the plurality of stabilizer legs comprise at least three stabilizer legs.

9. The self-stabilizing screwdriver of claim 3, wherein the plurality of stabilizer legs comprise six stabilizer legs.

10. The self-stabilizing screwdriver of claim 1, wherein the stabilizer comprises a flexible material that enables movement of the stabilizer relative to the housing.

11. The self-stabilizing screwdriver of claim 10, wherein the stabilizer comprises thermoplastic rubber.

12. The self-stabilizing screwdriver of claim 1, wherein the bottom surface has a smooth or slippery material layer with reduced or low-friction properties to facilitate the bottom surface sliding along the surface.

13. The self-stabilizing screwdriver of claim 12, wherein the smooth or slippery material layer comprises a UV material.

14. The self-stabilizing screwdriver of claim 1, further comprising a ratchet activator positioned within a housing aperture defined within a surface of the housing, wherein the ratchet activator activates a ratchet state of the self-stabilizing screwdriver, and wherein the ratchet state enables turning of the screwdriver bit clockwise by repeatedly turning the housing partially clockwise and partially counterclockwise.

15. A self-stabilizing screwdriver comprising:
a housing defining a housing cavity, wherein the housing comprises:
a top housing,
a bottom housing, wherein the bottom housing comprises a base, and
a bit aperture defined in the base, wherein the bit aperture provides access to the housing cavity;
a stabilizer coupled to the bottom housing, wherein the stabilizer comprises a plurality of stabilizer legs that are configured to move in an outward direction relative to the bottom housing when the self-stabilizing screwdriver is in operation; and
a screwdriver bit comprising a body and a tip, wherein the body extends through the bit aperture such that the tip of the screwdriver bit is positioned outside the housing and is surrounded by the plurality of stabilizer legs.

16. The self-stabilizing screwdriver of claim 15, wherein the stabilizer is removably coupled to the bottom housing.

17. The self-stabilizing screwdriver of claim 15, wherein the stabilizer further comprises a stabilizer ring coupled to the plurality of stabilizer legs, wherein the top housing forms a screwdriver body and the bottom housing is recessed from the top housing and forms a cylindrical body below the screwdriver body, and wherein the stabilizer ring is coupled to the cylindrical body such that the stabilizer legs extend below the housing.

18. The self-stabilizing screwdriver of claim 15, further comprising a ratchet system positioned within the housing, the ratchet system comprising:
a drive gear coupled to the screwdriver bit, wherein a rotation of the drive gear rotates the screwdriver bit; and
a ratchet activator coupled to the housing, wherein the ratchet activator is configured to activate a ratchet state or a screwdriver state of the self-stabilizing screwdriver depending on an orientation of the ratchet activator;
wherein the self-stabilizing screwdriver is in a ratchet state when the drive gear moves with the housing in a single direction and the self-stabilizing screwdriver is in a screwdriver state when the drive gear moves with the housing in both directions.

19. A self-stabilizing screwdriver, comprising:
a housing defining a housing cavity, wherein the housing comprises:
a top housing portion forming a screwdriver body,
a bottom housing portion, wherein the bottom housing portion forms a housing ring, wherein the housing ring comprises a housing ring outer surface, and
a base coupled to the bottom housing portion, wherein the base comprises a bit aperture configured to receive a screwdriver bit; and
a stabilizer comprising a stabilizer ring and a plurality of stabilizer legs coupled to the stabilizer ring, wherein the stabilizer ring comprises a stabilizer ring inner surface that couples to the housing ring outer surface, and wherein the stabilizer legs are configured to spread out along a surface when the stabilizer is in contact with the surface and the self-stabilizing screwdriver is in use.

20. The self-stabilizing screwdriver of claim 19, wherein the stabilizer is removably coupled to the bottom housing portion.
